(19) United States
(12) Patent Application Publication
(10) Pub. No.: US 2026/0023462 A1
(43) Pub. Date: Jan. 22, 2026

(54) SETTING SUPPORT DEVICE AND SETTING SUPPORT PROGRAM FOR MEASUREMENT DEVICE

(71) Applicant: Keyence Corporation, Osaka (JP)

(72) Inventor: Kimihiko SUGINO, Osaka (JP)

(73) Assignee: Keyence Corporation, Osaka (JP)

(21) Appl. No.: 19/032,148

(22) Filed: Jan. 20, 2025

(30) Foreign Application Priority Data
Jul. 18, 2024 (JP) 2024-114609

(51) Int. Cl. G06F 3/0484; G06F 3/0481; G06T 7/50

(52) U.S. Cl. CPC G06F 3/0484; G06F 3/0481; G06T 7/50

(57) ABSTRACT

To improve measurement accuracy of a pin even when a tip shape of the pin is different. A setting unit of a setting support device for a measurement device includes a tool for measuring a predetermined measurement object as a measurement item, receives designation of a measurement region, and sets a tool including a measurement region for measuring the measurement object and a filter parameter according to the designation of the measurement region and a size of the target region and/or a representative height in the target region. A symbol corresponding to the target region is displayed on the height image, a measurement object corresponding to the filter parameter in the measurement region is specified on the basis of the setting of the tool, and the measurement of the tool is executed based on the specified measurement value of the measurement object.

### CROSS-REFERENCE TO RELATED APPLICATIONS

The present application claims foreign priority based on Japanese Patent Application No. 2024-114609, filed Jul. 18, 2024, the contents of which are incorporated herein by reference.

### BACKGROUND OF THE INVENTION

### 1. TECHNICAL FIELD

The present disclosure relates to a setting support device and a setting support program for a measurement device that measures a measurement object.

### 2. DESCRIPTION OF THE RELATED ART

For example, a pin terminal bend inspection device disclosed in JP11-040307A is configured to acquire an image of a pin mounted on a circuit board or a pin provided in a connector plug in a state where the pin is irradiated with illumination light, and determine whether the pin is good or bad on the basis of a bend amount of the pin calculated on the basis of the acquired image.

In JP11-040307A, the bending amount of the pin is defined as a deviation amount of a pin tip center position from a pin root center position.

Meanwhile, in a case where a pin is optically measured as in JP11-040307A, noise is likely to be included in an image obtained by imaging the pin, and it may be difficult to correctly grasp the shape of the pin. In addition, as another example, in a case where a flaw on an object surface is optically measured, since the flaw itself has a fine shape, it may be difficult to correctly grasp the shape of the flaw. Division is different between an object and the noise according to the measurement object. As a result, the accuracy of the tip position of the pin and the flaw measurement may be deteriorated.

### SUMMARY OF THE INVENTION

The present disclosure has been made in diagram of such a point, and an object of the present disclosure is to improve measurement accuracy for a measurement object by facilitating setting of division between an object and a noise according to the measurement object.

In order to achieve the above object, a setting support device for a measurement device according to an aspect of the present disclosure includes: a receiving unit that receives shape data; a setting unit that sets one or more measurement elements and a measurement item using the one or more measurement elements; an execution unit that executes measurement of the measurement item set by the setting unit, on the shape data received by the receiving unit; and a screen generation unit that generates a display screen, the display screen including a display region for two-dimensionally and/or three-dimensionally displaying a height image, based on the shape data received by the receiving unit, and the one or more measurement elements on the height image, the display screen including a result display element indicating a result of the measurement executed by the execution unit.

The setting unit includes a tool for measuring a predetermined measurement object as the measurement item, the setting unit receives, in response to selection of the tool, designation of a measurement region on the height image and designation of a target region for specifying a measurement object in the measurement region, and sets a tool including a measurement region for measuring the measurement object and a filter parameter according to the designation of the measurement region, a size of the target region, and/or a representative height in the target region.

The screen generation unit displays a symbol according to the target region on the height image. The execution unit specifies the measurement object according to the filter parameter in the measurement region on a basis of setting of the tool, and executes measurement of the tool on a basis of a measurement value of the specified measurement object.

According to this configuration, when the tool is set, the designation of the measurement region and the designation of the target region for specifying the measurement object in the measurement region are received, so that it is possible to easily set the division between the target and the noise according to the measurement object.

In another aspect of the present disclosure, the setting support program for a measurement device executable by a processing device can be assumed. A setting support program for a measurement device can causing the processing device to execute: processing of receiving shape data; processing of setting one or more measurement elements and a measurement item using the one or more measurement elements; processing of measuring the measurement item, on the shape data; and processing of generating a display screen, the display screen including a display region for two-dimensionally and/or three-dimensionally displaying a height image based on the shape data and the one or more measurement elements on the height image, the display screen including a result display element indicating a result of the measurement, the storage medium further causing the processing device to execute: processing of receiving, in response to selection of a tool for measuring a predetermined measurement object, designation of a measurement region on the height image and designation of a target region for specifying a measurement object in the measurement region, and setting a tool including a measurement region for measuring the measurement object and a filter parameter according to the designation of the measurement region, a size of the target region, and/or a representative height in the target region; and processing of displaying a symbol according to the target region on the height image, specifying the measurement object according to the filter parameter in the measurement region on a basis of setting of the tool, and executing measurement of the tool on a basis of a measurement value of the specified measurement object.

As described above, according to the present disclosure, it is possible to improve measurement accuracy for a measurement object by facilitating setting of division between an object and a noise according to the measurement object.

### BRIEF DESCRIPTION OF THE DRAWINGS

FIG. 1 is a diagram explaining a configuration of a setting support device for a measurement device according to a first embodiment of the present invention;

FIG. 2 is a diagram explaining a configuration of a setting support device for a measurement device according to a second embodiment of the present invention;

FIG. 3 is a block diagram of the setting support device for the measurement device;

FIG. 4 is a flowchart illustrating an example of a flow of processing at the time of setting;

FIG. 5 is a perspective diagram of a measurement object;

FIG. 6 is a plan diagram of the measurement object;

FIG. 7 is a diagram illustrating an example of a pattern matching reference image;

FIG. 8 is a diagram explaining a case where pattern matching processing is executed on an input image;

FIG. 9 is a diagram illustrating a user interface screen for two-dimensionally and three-dimensionally displaying a measurement object;

FIG. 10 is a diagram illustrating a reference plane designation user interface screen;

FIG. 11 is a diagram illustrating a measurement region user interface designation screen;

FIG. 12 is a diagram explaining a designation operation for a plurality of measurement regions;

FIG. 13 is a diagram corresponding to FIG. 9 illustrating a state in which the designation operation for measurement regions is completed;

FIG. 14 is a diagram corresponding to FIG. 12 explaining a case of a measurement object having another shape;

FIG. 15 is a diagram illustrating a pin tool setting window;

FIG. 16 is a diagram illustrating an origin point designation window;

FIG. 17 is a diagram explaining a manner of origin point designation;

FIG. 18 is a diagram illustrating another example of the origin point designation window;

FIG. 19 is an example of a CSV file for designating center coordinates of each measurement region;

FIG. 20 is a conceptual diagram in a case where local coordinates are converted into global coordinates;

FIG. 21 is a diagram explaining a manner of coordinate-transforming a center position of local coordinates into a center position of global coordinates;

FIG. 22 is a diagram illustrating a plurality of pins having different tip shapes;

FIG. 23 is a diagram illustrating an example of screen display in a case of receiving designation of an initial value;

FIG. 24 is a flowchart illustrating an example of a flow of measurement processing;

FIG. 25 is a diagram illustrating a result display screen;

FIG. 26 is a diagram explaining a difference in display form between a case where the XY position of the pin tip is outside a tolerance range and a case where the XY position is within the tolerance range;

FIG. 27 is a flowchart illustrating a flow of processing after tool selection;

FIG. 28 is a schematic diagram illustrating processing contents of a flaw tool;

FIG. 29 is a diagram of a flaw tool window illustrating a case where the largest flaw is designated;

FIG. 30 is a diagram of a flaw tool window illustrating a case of designating a detection size;

FIG. 31 is a diagram explaining processing contents of a fine flaw tool;

FIG. 32 is a diagram of a fine flaw tool window illustrating a case where the largest flaw is designated;

FIG. 33 is a diagram of a fine flaw tool window illustrating a case where a detection size is designated; and

FIG. 34 is a flowchart illustrating an example of a flow of processing at the time of operating the measurement device.

### DETAILED DESCRIPTION

Hereinafter, a setting support device for a measurement device and a setting support program for a measurement device according to embodiments of the present invention will be described in detail with reference to the drawings. It is to be noted that the following description of preferred embodiments is merely exemplary in nature and is not intended to limit the present invention, its application, or its use.

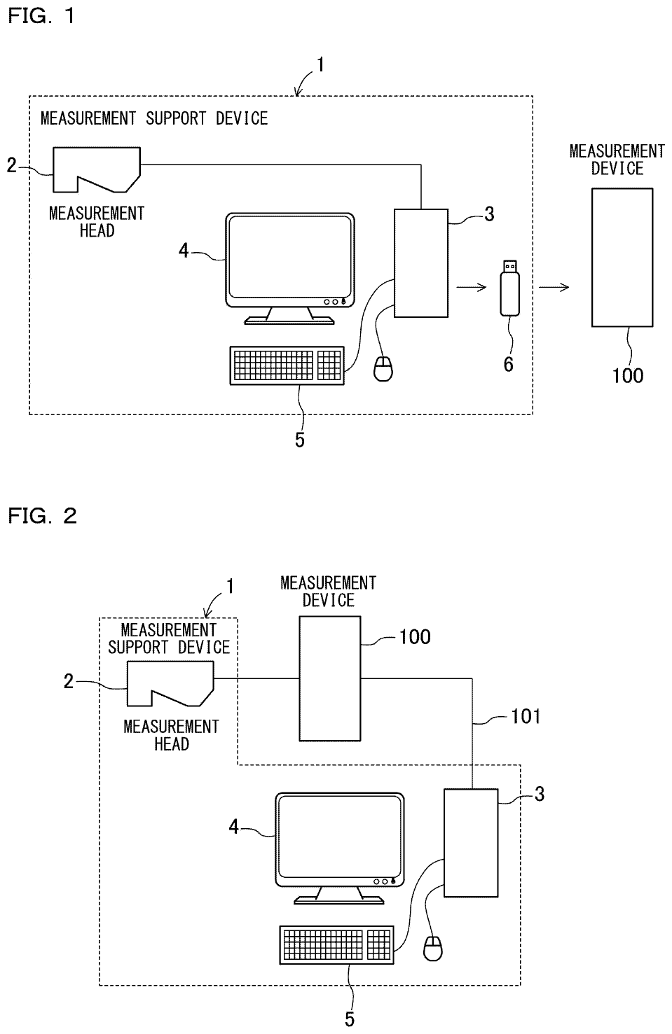

FIG. 1 is a diagram explaining a configuration of a setting support device 1 for a measurement device according to a first embodiment of the present invention. In the first embodiment, the setting support device (hereinafter, simply referred to as a “setting support device”) 1 for the measurement device and a measurement device 100 to be set by the setting support device 1 are separated. For example, in a case where the setting support device 1 and the measurement device 100 are installed in different places, or in a case where a user of the setting support device 1 and the user who uses the measurement device 100 on site are different from each other, the first embodiment can be applied to such a case.

The setting support device 1 of the first embodiment includes a measurement head 2, a processing device 3, a display unit 4, and an operation unit 5. In the processing device 3, measurement setting information is stored in the storage medium 6, and the measurement setting information can be read into the measurement device 100 via the storage medium 6. The storage medium 6 includes, for example, a semiconductor memory, a hard disk drive, an optical disk, or the like. After the measurement setting information created by the processing device 3 is stored in the storage medium 6, the storage medium 6 is removed from the processing device 3 and connected to the measurement device 100, whereby the measurement setting information stored in the storage medium 6 can be read by the measurement device 100. In the first embodiment, the storage medium 6 may be omitted, the setting support device 1 and the measurement device 100 may be connected via a communication line, and the measurement setting information created by the processing device 3 may be read by the measurement device 100 via the communication line. The communication line may be wired or wireless. In the case of the first embodiment, during operation, an image of a measurement object is acquired by another measurement head (not illustrated) of the measurement device 100, and measurement is executed.

FIG. 2 is a diagram explaining a configuration of a setting support device 1 for a measurement device according to a second embodiment of the present invention. In the second embodiment, the measurement device 100 and the setting support device 1 are used in a connected state. For example, the measurement device 100 and the setting support device 1 are connected via a communication line 101, and the measurement device 100 and the setting support device 1 can communicate with each other. The communication line may be wired or wireless.

Similarly to the first embodiment, the setting support device 1 of the second embodiment includes a measurement head 2, a processing device 3, a display unit 4, and an operation unit 5. In the case of the second embodiment, since the measurement head 2 is connected to the measurement device 100, the measurement device 100 may include the measurement head 2. In use, an image of the measurement object is acquired by the measurement head 2 and measurement is executed. In this case, the setting support device 1 can use the measurement head 2 of the measurement device 100 to perform measurement setting. The present invention is not limited thereto, and the measurement head 2 may be a part of the setting support device 1.

As described above, there are various embodiments of the setting support device 1, and the setting support device I can be used in an embodiment other than the first and second embodiments described above. The operation and effect of the setting support device 1 of the first embodiment are the same as those of the setting support device 1 of the second embodiment. The display unit 4 may not be included as a member constituting the setting support device 1. Alternatively, the setting support device I may be a device in which the display unit 4 and the processing device 3 are integrated. Alternatively, the setting support device I may be a device in which the operation unit 5 and the processing device 3 are integrated.

### Configuration of Measurement Head

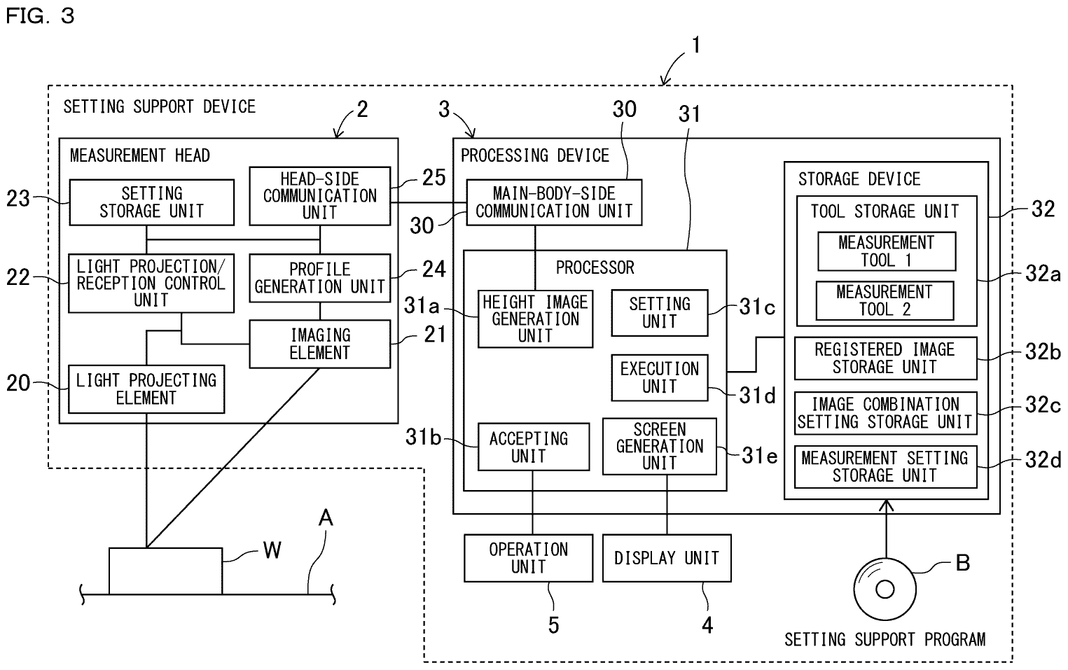

FIG. 3 is a block diagram of the setting support device 1. Since FIG. 3 is a diagram corresponding to the first embodiment illustrated in FIG. 1, the measurement head 2 is connected to the processing device 3. Although not illustrated, in the case of the second embodiment illustrated in FIG. 2, the measurement head 2 is connected to the measurement device 100, and the measurement device 100 is connected to the setting support device 1. Therefore, the measurement head 2 is connected to the setting support device 1 via the measurement device 100, but shape data acquired by the measurement head 2 can be received by the setting support device 1 via the measurement device 100.

The measurement head 2 is a device that captures an image of a measurement object W to generate shape data, and includes, for example, a device capable of acquiring three-dimensional shape data such as a profiler, a structured illumination three-dimensional camera, or a stereo camera. The measurement object W measured by the measurement head 2 is not particularly limited, and examples thereof include a device, an instrument, a member, a device, a unit, and the like having pins, and more specifically include a circuit board provided with one or more pins, a connector plug provided with one or more pins, an electric device having a circuit board or a connector plug, and the like. In addition, the measurement object W may be a member or the like manufactured by cutting, molding, or the like and having a flat surface or a curved surface. The measurement object W may be a member or the like having no pin.

The measurement object W may be in a stationary state, or may be conveyed in a predetermined direction by a conveyor A or the like, for example. In a site where a plurality of measurement objects W is sequentially conveyed, the conveyed measurement objects W can be sequentially measured by the measurement head 2.

The measurement head 2 includes a light projecting element 20, an imaging element 21, a light projection/reception control unit 22, a setting storage unit 23, a profile generation unit 24, and a head-side communication unit 25. The light projecting element 20 includes, for example, a light emitting diode (LED) or the like, and is a member that is disposed so as to face the measurement object W and irradiates the measurement object W with illumination light. The imaging element 21 includes, for example, an image sensor such as a complementary metal-oxide-semiconductor (CMOS), is arranged to face the measurement object W, receives light reflected from the measurement object W, generates a signal corresponding to the amount of received light, and outputs the signal to the profile generation unit 24.

The light projection/reception control unit 22 is a unit that controls the light projecting clement 20 and the imaging element 21. The setting storage unit 23 is a unit that stores setting information of light projection/reception. The setting information of light projection/reception includes, for example, a light emission amount and a light emission timing of the light projecting element 20, an imaging timing of the imaging clement 21, an exposure time, a gain, and the like. The setting information of light projection/reception stored in the setting storage unit 23 can be created by the setting support device 1 and transmitted to the measurement head 2 in the case of the first embodiment, and can be created by the setting support device 1 or the measurement device 100 and transmitted to the measurement head 2 in the case of the second embodiment. In either case, the setting information of light projection/reception can be stored in the setting storage unit 23, and the light projection/reception control unit 22 controls the light projecting element 20 and the imaging element 21 on the basis of the setting information of light projection/reception stored in the setting storage unit 23.

The profile generation unit 24 is a unit that generates shape data on the basis of a signal related to a light reception amount distribution transmitted from the imaging element 21, and includes, for example, a processor or the like. In the measurement head 2, a plane coordinate system (local coordinates) is determined in advance. The shape data generated by the profile generation unit 24 can be configured by plane position information according to a plane coordinate system determined in advance by the measurement head 2 and height information corresponding to each plane position in the plane coordinate system. For example, as the plane position information according to the plane coordinate system, the shape data can be configured by the XY coordinates of each point sequence arranged in a lattice pattern and the Z coordinates corresponding to each point sequence. Since the point sequences constituting the shape data are arranged in a lattice pattern in the XY direction, the point arrays are arranged at equal intervals in the X direction and arranged at equal intervals in the Y direction. The intervals in the X direction of the point sequence and the intervals in the Y direction of the point sequence may be the same or different. Such shape data is called a distance image or a height image, and image processing for a two-dimensional image can be applied by using height information as luminance information. The shape data may include luminance information or the like corresponding to each plane position in addition to the plane position information and the height information.

The head-side communication unit 25 includes a communication module, a communication interface, and the like capable of communicating with the main-body-side communication unit 30 of the processing device 3. The shape data generated by the profile generation unit 24 is transmitted to the processing device 3 via the head-side communication unit 25. The setting information of light projection/reception is received via the head-side communication unit 25.

The processing device 3 is configured by, for example, a desktop or notebook personal computer. The processing device 3 includes a main-body-side communication unit 30, a processor 31, and a storage device 32. The main-body-side communication unit 30 includes a communication module and a communication interface capable of communicating with the head-side communication unit 25 of the measurement head 2. The shape data generated by the profile generation unit 24 of the measurement head 2 is received by the main-body-side communication unit 30. Therefore, the main-body-side communication unit 30 is an example of an accepting unit of the present invention. The shape data is not limited to the data generated by the measurement head 2, and may be three-dimensional CAD data, for example. In the case of CAD data, for example, the CAD data can be received by the main-body-side communication unit 30 via a communication line such as the Internet.

The processor 31 includes, for example, a central processing unit (CPU), a read only memory (ROM), a random access memory (RAM), and the like. The ROM stores, for example, a system program and the like. The ROM is used as a work area when the central processing unit executes various processes.

The storage device 32 stores a setting support program (hereinafter, simply referred to as a “setting support program”) of the measurement device executable by the processing device 3. The setting support program can be distributed in a state of being stored in a storage medium B such as an optical disk or a semiconductor memory, or can be distributed through, for example, an Internet line. In any distribution form, the setting support program can be stored in the storage device 32, that is, can be installed.

The processor 31 can configure a height image generation unit 31a, an accepting unit 31b, a setting unit 31c, an execution unit 31d, and a screen generation unit 31e by executing the setting support program stored in the storage device 32. The height image generation unit 31a, the accepting unit 31b, the setting unit 31c, the execution unit 31d, and the screen generation unit 31e can be configured by a combination of hardware and software. In addition, a part of the height image generation unit 31a, the accepting unit 31b, the setting unit 31c, the execution unit 31d, and the screen generation unit 31e may be configured by one or a plurality of other processors (not illustrated). The other processor may be provided in a place different from the processor 31. When the processor 31 executes the setting support program, it is possible to cause the processing device 3 to execute each processing described later.

The setting unit 31c is a unit that executes processing of setting one or more measurement elements and a measurement item using the one or more measurement elements at the time of setting by the setting support device 1. The execution unit 31d is a unit that executes measurement of the measurement item set by the setting unit 31c on the shape data received by the main-body-side communication unit 30 when executing measurement after setting, and the execution unit 31d executes processing of executing measurement of the measurement item on the shape data.

The setting support program may be stored in a ROM or the like instead of the storage device 32 or in addition to the storage device 32. In addition, the processor 31 may directly read and execute the setting support program from the storage medium B. The setting support program may be stored on a so-called cloud server, and in this case, the setting support device 1 can perform setting support by accessing the cloud server.

The operation unit 5 includes, for example, a keyboard, a mouse, various pointing devices, and the like. The operation unit 5 is connected to the accepting unit 31b of the processor 31. The operation state of the operation unit 5 by the user is received by the accepting unit 31b. As a result, it is possible to detect what operation the user has performed.

The display unit 4 includes, for example, a liquid crystal display panel, an organic electro luminescence (EL) panel, or the like. The display unit 4 is connected to the screen generation unit 31e of the processor 31. Data constituting the display screen generated by the screen generation unit 31e is transmitted to the display unit 4 and displayed on the display unit 4.

The storage device 32 is provided with a tool storage unit 32a. The tool storage unit 32a stores a plurality of measurement tools (for example, the measurement tool 1, the measurement tool 2, and the like) for performing various measurements. The measurement tool includes a pin tool for measuring a pin as a measurement item, and further includes a tool for measuring a height, a tool for measuring flatness, and the like.

Furthermore, the storage device 32 is provided with a registered image storage unit 32b, an image combination setting storage unit 32c, and a measurement setting storage unit 32d. The registered image storage unit 32b stores an image of the measurement object W captured in advance. The image combination setting storage unit 32c stores setting information such as the presence or absence of composition processing of the height image. The measurement setting storage unit 32d stores a measurement element, a measurement item, and the like.

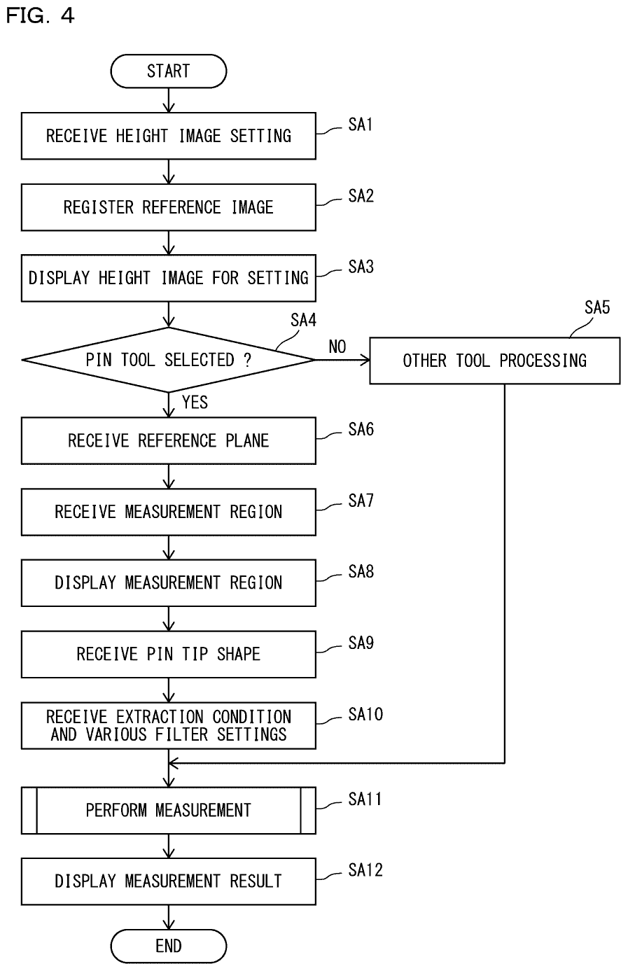

FIG. 4 is a flowchart illustrating a flow of processing at the time of setting by the setting support device 1. At the time of setting, when the user operates the operation unit 5, the setting unit 31c can execute processing of setting the measurement element and the measurement item using the measurement clement. Hereinafter, the setting will be specifically described.

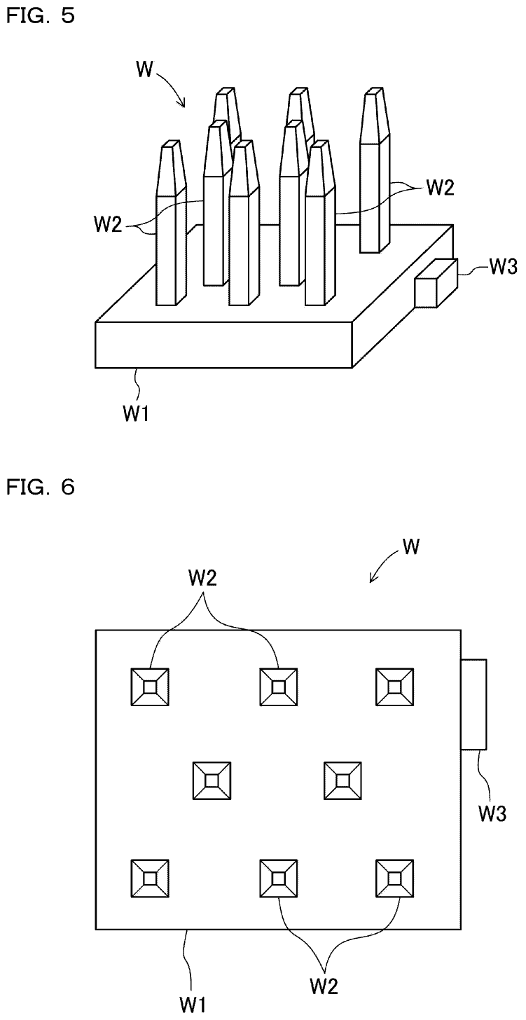

This flowchart is started when a setting execution operation is performed by the user. In the present embodiment, an example of measuring the measurement object W as illustrated in FIGS. 5 and 6 as an example will be described. The measurement object W includes a substrate W1, a plurality of pins W2 provided so as to protrude upward from the substrate W1, and a protrusion W3 protruding from an edge portion of the substrate W1.

When the setting execution operation is performed by the user, the measurement head 2 is caused to image the measurement object W, and the main-body-side communication unit 30 receives the shape data generated by the profile generation unit 24 of the measurement head 2. This processing is processing of receiving the shape data.

Then, in step SA1, the setting of the height image is received. In step SA1, the height image generation unit 31a reads the presence or absence of the synthesis processing of the height image stored in the image combination setting storage unit 32c, and in a case where the synthesis processing of the height image is present, the synthesis processing of the height image is executed using the shape data. As a result, a height image is obtained, and the obtained height image is temporarily stored. In a case where the synthesis processing of the height image is not executed, the synthesis processing of the height image is not executed. In step SA1, the IP address of the measurement head 2 can also be designated.

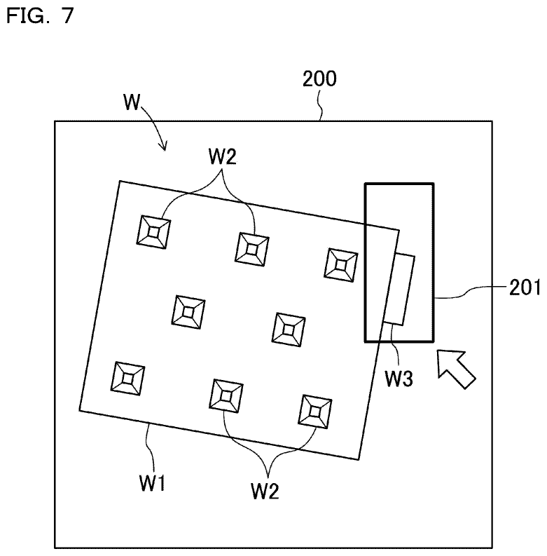

In step SA2, for example, a pattern matching reference image 200 as illustrated in FIG. 7 is registered. The pattern matching reference image 200 is an image obtained by imaging the measurement object W from above by the measurement head 2, and is used when the height image input at the start of setting is aligned so as to have a predetermined position and inclination.

In step SA2, the designation of the alignment region 201 in the pattern matching reference image 200 is received from the user. In a state where the screen generation unit 31e displays the pattern matching reference image 200 on the display unit 4, the user operates the operation unit 5 to designate the alignment region 201. The designation operation for the alignment region 201 is received by the accepting unit 31b. In this embodiment, the alignment region 201 is designated so as to include the protrusion W3 having a characteristic shape in plan view. The pattern matching reference image 200 and the alignment region 201 are stored in the registered image storage unit 32b in an associated state.

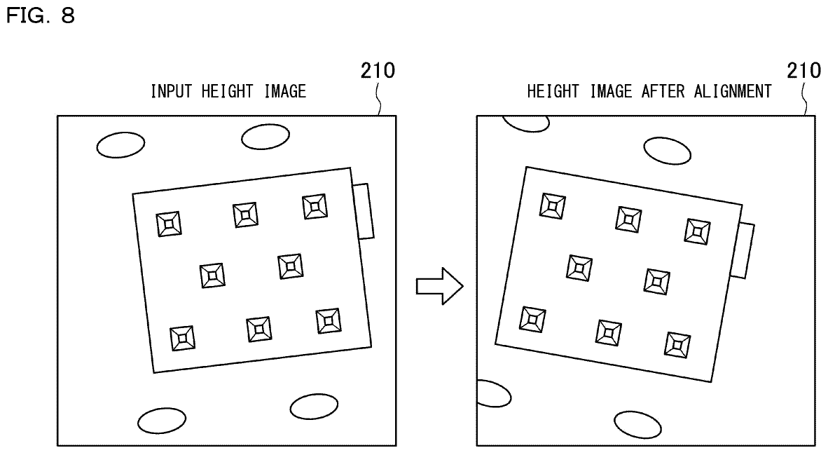

For example, in a case where a height image (input image 210) as illustrated on the left side of FIG. 8 is input, the execution unit 31d executes pattern matching on the basis of the pattern matching reference image 200 and the alignment region 201 illustrated in FIG. 7. As a result, as illustrated on the right side of FIG. 8, the input image 210 can be rotated and moved in the X direction and the Y direction as necessary to be matched with the pattern matching reference image 200 illustrated in FIG. 7. Note that pattern matching need not be performed, and step SA2 can be omitted in a case where pattern matching is not performed.

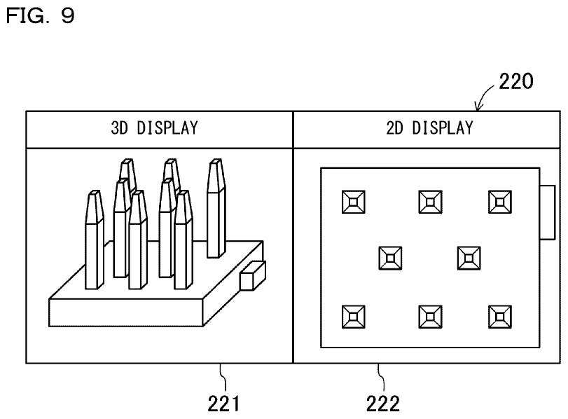

In step SA3, as illustrated in FIG. 9, the screen generation unit 31e generates the setting display screen 220 for displaying the setting image, and displays the setting display screen 220 on the display unit 4. The setting display screen 220 is provided with a three-dimensional display region 221 for three-dimensionally displaying the height image of the measurement object W and a two-dimensional display region 223 for two-dimensionally displaying the height image of the measurement object W. The screen generation unit 31e generates a user interface screen capable of simultaneously three-dimensionally displaying the height image and two-dimensionally displaying the height image. In this manner, the screen generation unit 31e executes processing of generating various display screens. Note that the screen generation unit 31e may generate a user interface screen capable of only one of three-dimensional display of the height image and two-dimensional display of the height image, or the screen generation unit 31e may generate a user interface screen capable of switching operation between three-dimensional display of the height image and two-dimensional display of the height image.

In step SA4, it is determined whether or not the pin tool is selected by the user from the plurality of measurement tools. When the measurement tool is selected, the screen generation unit 31e generates a measurement tool selection user interface screen and displays the user interface screen on the display unit 4. On the measurement tool selection user interface screen, various measurement tools can be selected in addition to the pin tool, and a user can select a desired measurement tool by operating the operation unit 5. Other measurement tools may include a flaw tool for measuring a flaw such as a dent on the surface of the measurement object W on which a flat surface or a curved surface is formed, and a fine flaw tool for measuring a flaw finer than the flaw such as a dent. In the present embodiment, the setting unit 31c includes a pin tool for measuring a pin as one of the measurement items, and in the pin tool, a pin can be set as a measurement element and a measurement item using the pin can be set. When selection of the pin tool is received by the accepting unit 31b, the setting unit 31c is in a state of selecting the pin tool. On the other hand, when the accepting unit 31b receives that the measurement tool other than the pin tool is selected, the setting unit 31c enters a state in which the measurement tool other than the pin tool (referred to as another tool) is selected.

In a case where another tool, which is a tool other than the pin tool, is selected, NO is determined in step SA4, the processing proceeds to step SA5, and another tool processing is executed. Another tool may include a flaw tool or a fine flaw tool. In a case where the pin tool is selected, YES is determined in step SA4, and the process proceeds to step SA6.

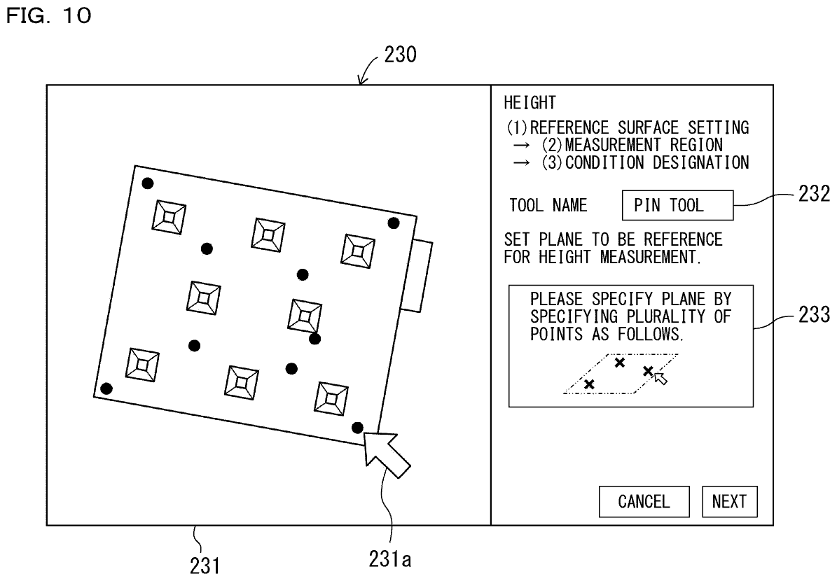

In step SA6, the setting unit 31c receives the designation of the reference plane. The reference plane is a measurement element, and in the present embodiment, a measurement item using a pin and the reference plane can be set. Specifically, a reference plane designation user interface screen 230 as illustrated in FIG. 10 is generated by the screen generation unit 31e and displayed on the display unit 4. The reference plane designation user interface screen 230 is provided with an image display region 231 for two-dimensionally displaying the height image of the measurement object W, a tool name display region 232, and an operation explanation region 233. In the tool name display region 232, “pin tool” is displayed as the selected tool name. Since an operation procedure for designating the reference plane is displayed in the operation explanation region 233, the user can perform a designation operation for the reference plane while viewing the operation procedure displayed in the operation explanation region 233.

A white arrow indicated by reference numeral 231a in the image display region 231 is a pointer of a mouse included in the operation unit 5. When the user operates the operation unit 5, the pointer 231a can be moved on the image in which the height image is two-dimensionally displayed (the image displayed in the image display region 231). The user performs an operation of sequentially designating at least three points on the height image with the pointer 231a. For example, when the upper surface of the substrate W1 of the measurement object W is set as the reference plane, the pointer 231a is moved to an arbitrary position on the upper surface of the substrate W1 and clicked, so that the position is designated as the first point for designating the plane, and the X coordinate and the Y coordinate of the first point are acquired. That is, the user designates the X coordinate and the Y coordinate of the point for designating the reference plane. This is repeated to designate the second point and the third point on the upper surface of the substrate W1. The designation of the first to third points is received by the setting unit 31c. The setting unit 31c may receive designation of the fourth, fifth, . . . points.

By designating three or more points at the time of setting, at the time of measurement, a plane fitted to the height of each pixel at the position specified by the X coordinate and the Y coordinate of at least three points designated at the time of setting can be specified as a reference plane. The height from the reference plane can be used as a measurement value. Note that, in addition to the height from the reference plane, the Z coordinate (the height of the measurement head 2) itself of the height image may be set to be used as the measurement value.

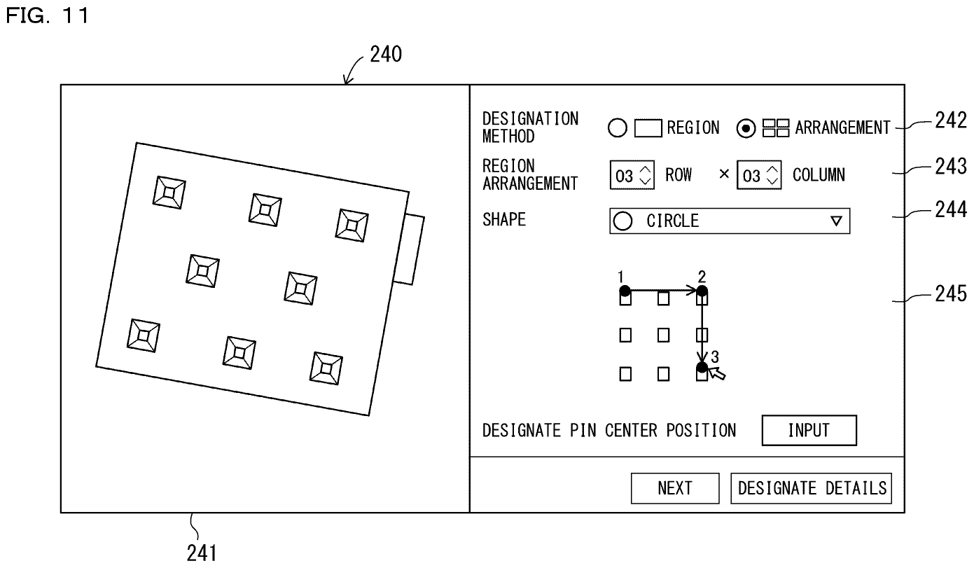

In step SA7, the setting unit 31c receives designation of the measurement region in response to selection of the pin tool. Specifically, a measurement region user interface designation screen 240 as illustrated in FIG. 11 is generated by the screen generation unit 31e and displayed on the display unit 4. The measurement region user interface designation screen 240 is provided with an image display region 241 for two-dimensionally displaying the height image of the measurement object W, a designation method selection region 242, an arrangement designation region 243, a shape designation region 244, and an operation explanation region 245. In the designation method selection region 242, it is possible to select whether to designate the measurement region as “region” or “array”. In a case where the measurement region is designated as “array”, it means that a plurality of measurement regions exist in a certain range, and the arrangement of the measurement regions arranged in the existence range is designated. Specifically, the number of measurement regions arranged in the existence range in the row direction and the number of measurement regions in the column direction are individually designated in the arrangement designation region 243. As a result, the arrangement of the plurality of measurement regions arranged in the existence range can be specified. The setting unit 31c receives designation in the designation method selection region 242 and designation in the arrangement designation region 243.

In the shape designation region 244, the shape of the measurement region can be designated. Examples of the shape of the measurement region include a circle and a rectangle. When the measurement region is designated as “array”, the shape of the measurement region is designated collectively for all of the plurality of measurement regions. As a result, the setting unit 31c receives designation of the shape of the measurement region in the shape designation region 244.

In a case of designating the measurement region as “array”, the setting unit 31c specifies the existence ranges of the plurality of measurement regions on the basis of designation of three points on the height image by the user. In the operation explanation region 245, an operation procedure for designating the existence range of the measurement region is displayed, and it is shown that it is sufficient to perform an operation of sequentially designating three points. The user can perform an operation of specifying the existence range of the measurement region while viewing the operation procedure displayed in the operation explanation region 245.

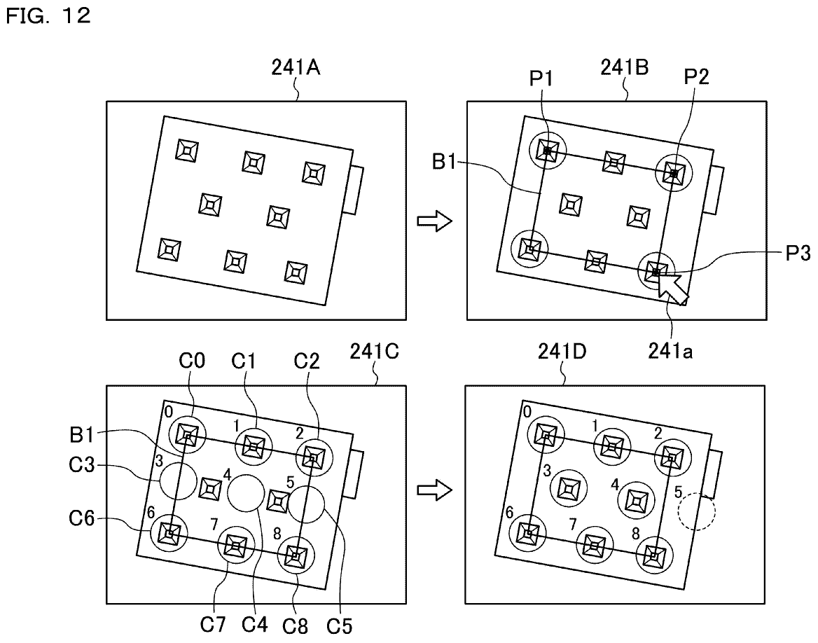

Specifically, in a case where the height image of the measurement object W is two-dimensionally displayed as illustrated in an image display region 241A of FIG. 12, as illustrated in an image display region 241B, the user operates the pointer 241a by the operation unit 5 to sequentially designate the points P1, P2, and P3 as in the case of designating the reference plane. The designation order of the points P1, P2, and P3 is the order displayed in the operation explanation region 245 of FIG. 11. When the points P1, P2, and P3 are designated, the screen generation unit 31e generates a rectangular box BI having the points P1, P2, and P3 as vertices, and displays the rectangular box B1 in the image display region 241B. By designating the points P1, P2, and P3, even if the existence range of the measurement region is inclined with respect to the horizontal line of the screen, the rectangular box B1 having an inclination angle corresponding to the inclination can be generated.

Simultaneously with the display of the rectangular box BI or after the display of the rectangular box B1, as illustrated in an image display region 241C, the screen generation unit 31e generates region boxes C0 to C8 indicating the position, size, and shape of the measurement region, and displays the region boxes C0 to C8 in the image display region 241C. The region boxes C0 to C8 correspond to the measurement region, and the user can grasp the size, position, and the like of the measurement region by viewing the region boxes C0 to C8.

This example illustrates a case where the number in the row direction is designated as 3 and the number in the column direction is designated as 3 in the arrangement designation region 243 illustrated in FIG. 11. Therefore, in the image display region 241C of FIG. 12, region boxes C0 to C8 indicating nine measurement regions are automatically displayed. In the initial setting, the intervals in the row direction of the region boxes C0 to C8 and the intervals in the column direction of the region boxes C0 to C8 are set at equal intervals. Specifically, the intervals in the row direction of the region boxes C0 to C8 are set to intervals obtained by equally dividing the dimension in the row direction of the rectangular box B1, and the intervals in the column direction of the region boxes C0 to C8 are set to intervals obtained by equally dividing the dimension in the column direction of the rectangular box B1.

As shown in this example, the number of pins W2 of the measurement object W is 8, which may be different from the number designated in the arrangement designation region 243. In this case, as illustrated in an image display region 241D, the user operates the operation unit 5 to delete the region box C5, and changes the positions of the region boxes C3 and C4 such that the pins W2 enter. In this manner, the user can delete any one or more region boxes among the region boxes C0 to C8 and move any one or more region boxes by operating the operation unit 5. The setting unit 31c receives designation of a region box to be deleted and movement of the region box.

The size of the measurement region at the time of initial setting is set so that adjacent measurement regions do not contact each other. The size of the measurement region at the time of the initial setting can be changed so as to correspond to the actual size of the existing region of the pin W2. The user can change the size of the region box C0 to an arbitrary size by operating the operation unit 5, for example, selecting the region box C0, and dragging the region box C0 in a decreasing direction and an increasing direction. Since the thicknesses of the plurality of pins W2 are often the same, when the size of the region box C0 is changed, the screen generation unit 31e changes the sizes of the other region boxes C0 to C4 and C6 to C8 to the same size as the region box C0 and displays the same in the image display region 241D. In this manner, for example, the sizes of the other region boxes C0 to C4 and C6 to C8 are changed in conjunction with the change in the size of the region box C0.

The change in the sizes of the region boxes C0 to C4 and C6 to C8 is received by the setting unit 31c. That is, the setting unit 31c receives a change in the size of the first measurement region (for example, the region box C0) which is an arbitrary measurement region among the plurality of measurement regions arranged in the existence range, and when the change in the size of the first measurement region is received, the sizes of the other measurement regions (for example, the region boxes Cl to C8) are set to the size after the change of the first measurement region. As a result, since the sizes of the plurality of region boxes C0 to C8 can be collectively changed, the burden at the time of setting by the user can be reduced.

When the positions and sizes of the region boxes C0 to C8 are changed by the user's operation, the center coordinates of each measurement region are changed. When the positions and sizes of the region boxes C0 to C8 are determined, the setting unit 31c specifies the center coordinates of each measurement region.

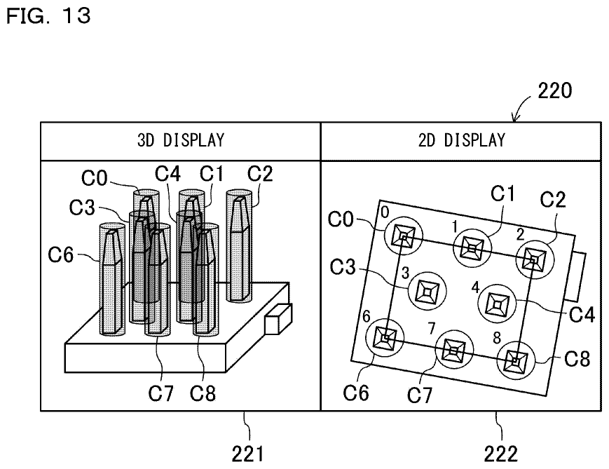

When the setting of the region boxes C0 to C8 is completed, the process proceeds to step SA8. In step Sa8, as illustrated in FIG. 13, in the three-dimensional display region 221, the region boxes C0 to C8 (excluding the region box C5) are displayed in a three-dimensional shape having a length in the height direction of the pin W2, and in the two-dimensional display region 223, the region boxes C0 to C8 (excluding the region box C5) are displayed in a planar manner. As a result, the user can easily determine whether or not the settings of the region boxes C0 to C8 correspond to the measurement object W. After the confirmation, the positions, shapes, and sizes of the region boxes C0 to C8 can also be corrected.

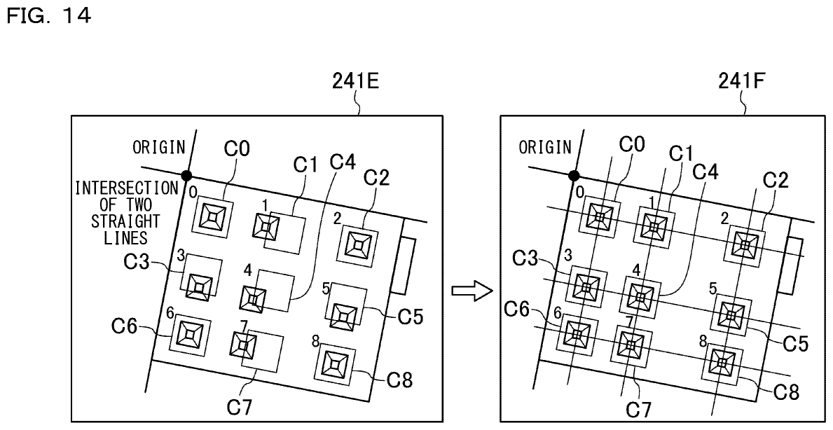

The arrangement of the pins W2 of the measurement object W may be different from those in FIGS. 5 and 6. FIG. 14 illustrates an image display region 241E in which a height image of such a measurement object W is two-dimensionally displayed. In this case, the origin of the local coordinates and the center coordinates of each measurement region are designated. The center coordinates of each measurement region can be input in, for example, a CSV file.

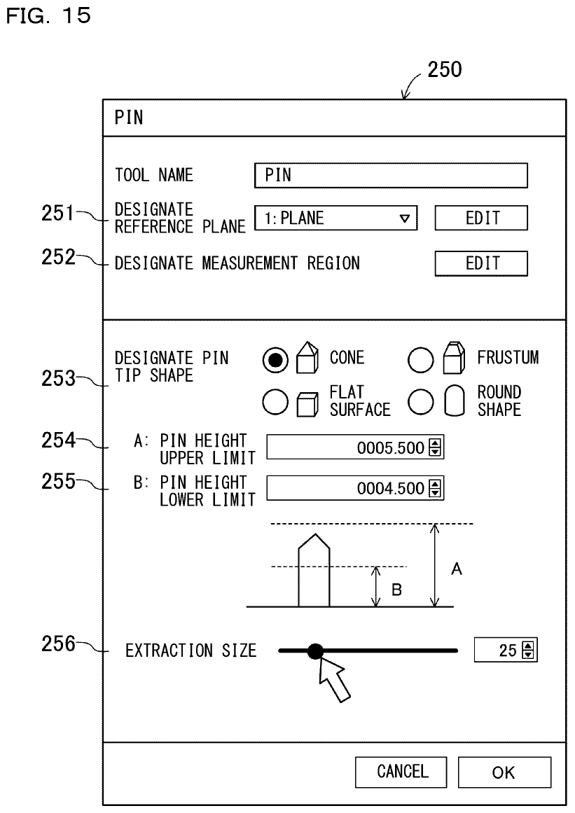

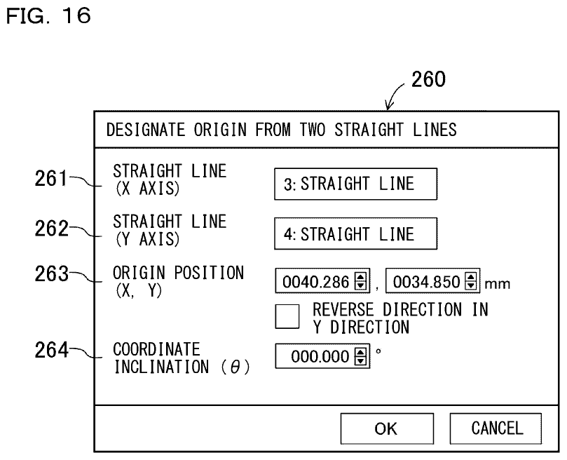

That is, when the measurement region of the measurement object W illustrated in FIG. 14 is set, the screen generation unit 31e generates a pin tool setting window 250 as illustrated in FIG. 15 and displays the pin tool setting window 250 on the display unit 4. The pin tool setting window 250 is provided with a reference plane designation section 251 for designating the reference plane described above, a measurement region designation section 252 for designating the measurement region, a pin tip shape designation section 253, a pin height upper limit input section 254, a pin height lower limit input section 255, and an extraction size input section 256. When the user operates the edit button of the measurement region designation section 252, the screen generation unit 31e generates an origin point designation window 260 illustrated in FIG. 16 and displays the origin point designation window 260 on the display unit 4. The origin point designation window 260 is provided with an X axis designation section 261 that designates the straight line of the X axis, a Y axis designation section 262 that designates straight line of the Y axis, an origin point designation section 263 that designates the origin point, and an inclination designation section 264 that designates the inclination of the coordinates.

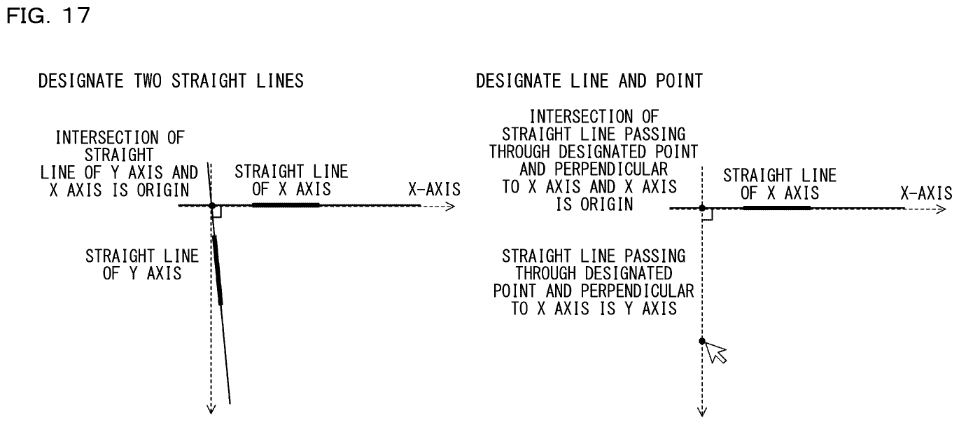

FIG. 17 is a diagram explaining a procedure in a case where the origin is designated using the origin point designation window 260 illustrated in FIG. 16. The diagram illustrated on the left side of FIG. 17 is a case where two straight lines of the straight line of the X axis and the straight line of the Y axis are designated. The X axis straight line can be designated by the X-axis designation section 261 illustrated in FIG. 16, and straight line of the Y axis can be designated by the Y axis designation section 262. An intersection of two designated straight lines is designated as an origin.

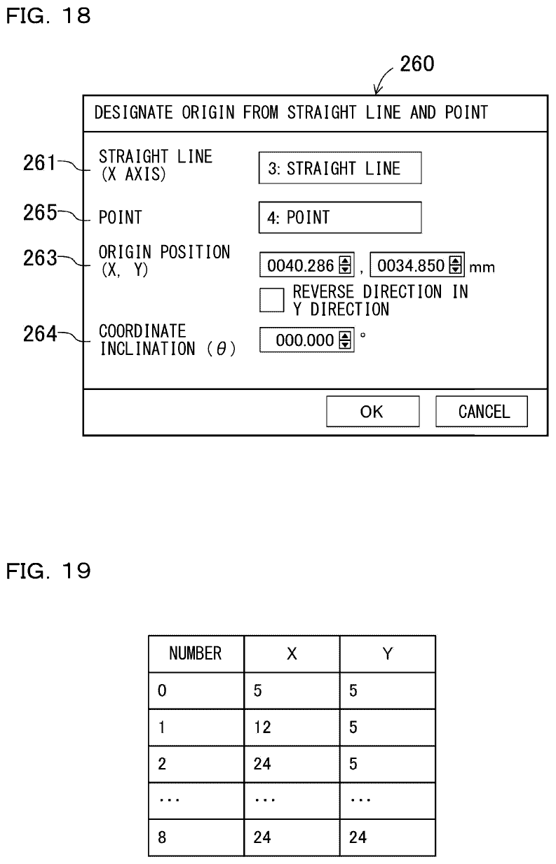

The diagram illustrated on the right side of FIG. 17 is a case where a straight line and a point of the X axis are designated. In this case, the screen generation unit 31e generates the origin point designation window 260 as illustrated in FIG. 18 and displays the origin point designation window 260 on the display unit 4. The origin point designation window 260 is provided with a point designation unit 265 that designates a point instead of the Y axis designation unit 262. A straight line of the X axis can be designated by the X axis designation unit 261 illustrated in FIG. 18, and a point can be designated by the point designation unit 265. A straight line passing through the designated point and perpendicular to the X axis is defined as a Y axis, and the origin is designated by the Y axis and the designated straight line of the X axis. The designated origin is the origin in the local coordinates, and can be displayed, for example, in image display regions 241E and 241F illustrated in FIG. 14.

After the origin is designated as described above, the center coordinates of each measurement region are designated on the basis of the origin. A method of designating the center coordinates of each measurement region is not particularly limited, but for example, designation by a CSV file as illustrated in FIG. 19 can be adopted. As an example, the CSV file includes up to 0 to 8 measurement region numbers, and the X coordinate and the Y coordinate of each measurement region are included in association with the measurement region number. The CSV file illustrated in FIG. 19 is a file indicating the position of the pin W2 of the measurement object W illustrated in the image display region 241E in FIG. 14.

The setting unit 31c reads the CSV file to set the center coordinates of each measurement region. As illustrated in FIG. 14, the screen generation unit 31e generates the region boxes C0 to C8 on the basis of the center coordinates of each measurement region and displays the region boxes C0 to C8 in the image display region 241F. The sizes of the region boxes C0 to C8 can be changed as described above.

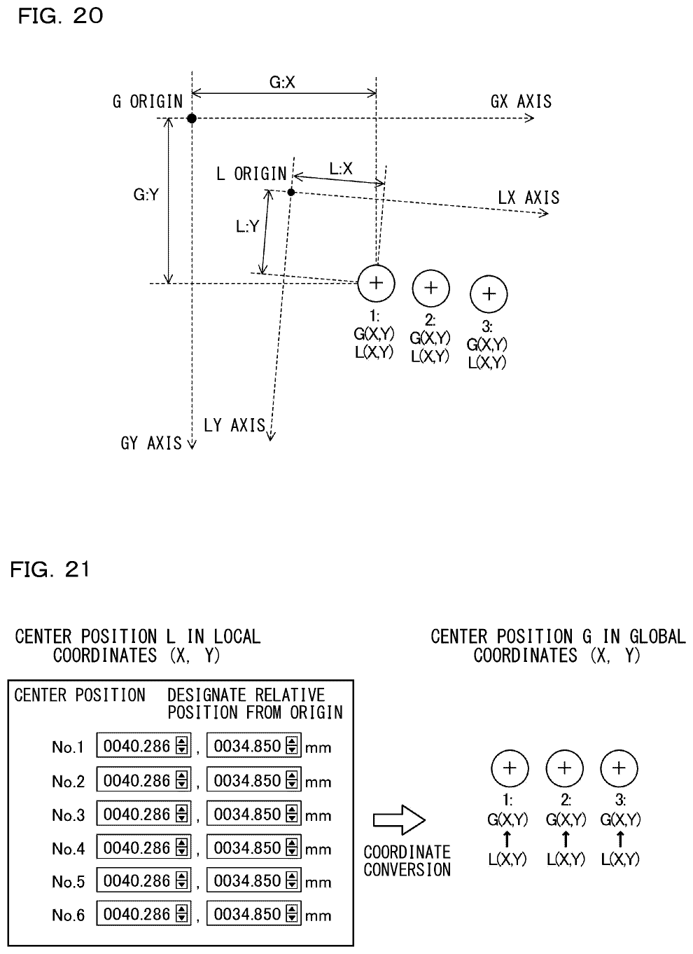

After the setting unit 31c receives the designation of the reference plane, when the center coordinates of each measurement region are set in local coordinates, the setting unit 31c switches the local coordinates to global coordinates. As illustrated in FIG. 20, the L origin (origin of local coordinates) is set as the G origin (origin of global coordinates), the LX axis (X axis of local coordinates) is set as the GX axis (X axis of global coordinates), and the LY axis (Y axis of local coordinates) is set as the GY axis (Y axis of global coordinates). Furthermore, as illustrated in FIG. 21, the center position L(X, Y) of the local coordinates is coordinate-transformed into the center position G(X, Y) of the global coordinates.

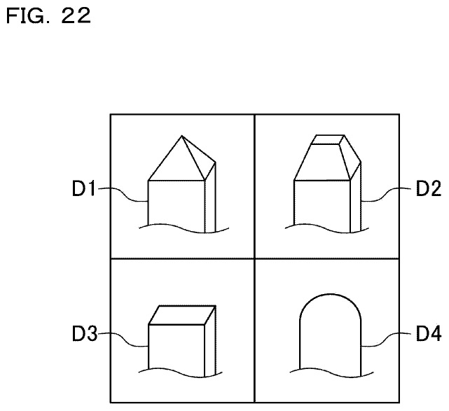

In step SA9 illustrated in FIG. 4, the setting unit 31c receives designation of the tip shape of the pin W2 of the measurement object W in response to selection of the pin tool. As illustrated in FIG. 22, for example, the tip shape of the pin W2 includes a cone (includes a truncated cone, a pyramid, and the like) D1, a frustum (truncated cone) D2, a flat surface D3, a curved surface (round shape, including hemispherical surface) D4, and the like. In a case where the tip shape is a truncated cone or a truncated frustum, the pin shape is a cylindrical shape, and in a case where the tip shape is a pyramid or a truncated pyramid, the pin shape is a prismatic shape.

The designation of the tip shape of the pin W2 can be performed by the pin tip shape designation section 253 of the pin tool setting window 250 illustrated in FIG. 15. In the pin tip shape designation section 253, the user can designate a cone, a frustum, a flat surface, and a curved surface (hereinafter, also referred to as a round shape) by operating the operation unit 5. The tip shape of the pin designated by the pin tip shape designation section 253 is received by the setting unit 31c, and is included in the setting contents as information regarding the tip shape of the pin.

The setting unit 31c includes a tool for measuring a pin as a measurement item, receives designation of a reference plane, designation of a measurement region of the pin, and designation of a tip shape of the pin in response to selection of the pin tool, and executes processing of setting the tool for measuring the pin in response to reception of designation of the reference plane, designation of the measurement region of the pin, and designation of the tip shape of the pin.

Here, measurement by the execution unit 31d will be described. On the basis of the setting of the pin tool by the setting unit 31c, the execution unit 31d obtains a measurement value in the measurement region by a different algorithm according to the tip shape of the pin, and executes the measurement of the pin tool on the basis of the measurement value. In a case where the execution unit 31d obtains the measurement value from the reference plane in the measurement region, the measurement value can be obtained by a different algorithm according to the tip shape of the pin. That is, the execution unit 31d obtains the tip height of the pin as the measurement value by a different algorithm according to the tip shape of the pin.

In a case where the tip shape of the pin is a cone, the execution unit 31d applies an algorithm in which the maximum height of the measurement region is the tip height of the pin. In a case where the tip shape of the pin is a frustum or a truncated cone, the execution unit 31d applies an algorithm in which the maximum height of the center region in the measurement region is set as the tip height of the pin. In a case where the tip shape of the pin is a flat surface, the execution unit 31d applies an algorithm in which the average height of the center region in the measurement region is set as the tip end height of the pin. In a case where the tip shape of the pin is a round shape, the execution unit 31d applies an algorithm in which the average height of the top n % of the heights of the measurement region is set as the tip height of the pin. n can be an arbitrary numerical value, and can be, for example, 5, 10, or the like. n may be changeable by the user.

The execution unit 31d can obtain the tip end position of the pin as the measurement value by a different algorithm according to the tip shape of the pin. In a case where the tip shape of the pin is a cone, the execution unit 31d applies an algorithm in which the position at the maximum height in the measurement region is set as the center position of the tip of the pin. In a case where the tip shape of the pin is a frustum or a truncated cone, the execution unit 31d applies an algorithm in which the maximum height position of the center region in the measurement region is set as the center position of the tip of the pin. In a case where the tip shape of the pin is a flat surface, the execution unit 31d applies an algorithm in which the position of the center of gravity of the measurement region is set as the center position of the tip of the pin. In addition, in a case where the tip shape of the pin is a round shape, the execution unit 31d applies an algorithm in which the position of the center of gravity of the region of the top n % of the heights of the measurement region is set as the center position of the tip of the pin.

In this manner, the execution unit 31d executes the measurement by applying a different algorithm for each tip shape of the pin. Which algorithm is applied is set at the time of setting. That is, when the cone is designated by the pin tip shape designation section 253 in FIG. 15, the algorithm for obtaining the tip height in the case of the cone and the algorithm for obtaining the center position of the tip in the case of the cone are automatically set by the setting unit 31c, so that the setting operation of the algorithm by the user is unnecessary. Note that the user may set an algorithm applied in the case of the cone.

When a frustum is designated by the pin tip shape designation section 253, an algorithm for obtaining the tip height in the case of the frustum and an algorithm for obtaining the center position of the tip in the case of the frustum are automatically set by the setting unit 31c. When the flat surface is designated by the pin tip shape designation section 253, an algorithm for obtaining the tip height in the case of the flat surface and an algorithm for obtaining the center position of the tip in the case of the flat surface are automatically set by the setting unit 31c. When the round shape is designated by the pin tip shape designation section 253, an algorithm for obtaining the tip height in the case of the round shape and an algorithm for obtaining the center position of the tip in the case of the round shape are automatically set by the setting unit 31c. Note that the algorithm for obtaining the center position of the tip may be a position of the center of gravity position of a region of a predetermined height threshold or more regardless of the tip shape. The above algorithm is an example, and other algorithms may be used.

When step SA9 in FIG. 4 ends as described above, the process proceeds to step SA10. In step SA10, the setting unit 31c receives the setting of the extraction condition of the pin candidate in the image and the setting of various filters. Specifically, the user can perform each setting using the pin tool setting window 250 as illustrated in FIG. 15.

Here, a case where the execution unit 31d extracts a pin candidate will be described. The execution unit 31d executes binarization processing on the shape data using a threshold set in advance, then sets a region extracted by executing blob processing as a pin candidate region, and executes filter processing on the pin candidate region. The threshold for the binarization processing may be determined by the setting unit 31c on the basis of each representative height of each measurement region. For example, the setting unit 31c estimates the height upper limit and the height lower limit of the pin candidate on the basis of the distribution of the representative heights such as frequency distribution, and sets the estimated height upper limit and the estimated height lower limit as the upper limit threshold and the lower limit threshold for the binarization processing. In a case where the height upper limit and the height lower limit are set as thresholds for the binarization processing, the execution unit 31d extracts a pixel having a height between the upper limit threshold and the lower limit threshold in each measurement region of the shape data as a pin candidate region. Subsequently, the execution unit 31d recognizes each pixel extracted by the binarization processing as a pin candidate region by executing the blob processing on the extracted pixel.

After the binarization processing, the execution unit 31d calculates the surface, the peripheral length, and the position of the contour of the region extracted by the blob processing, and executes the filter processing according to the calculated area size, the peripheral length, and the contour position. As the filter processing, the execution unit 31d can execute shape filter processing in which the shape of the pin candidate region is a target of the filter processing, execute height filter processing in which the height of the pin candidate region is a target of the filter processing, and execute size filter processing in which the size of the pin candidate region is a target of the filter processing.

For example, the threshold used for the binarization processing is set by the setting unit 31c in step SA10. After the binarization processing, the noise included in the shape data may appear as a whisker-like shape, and thus it is necessary to correctly distinguish the noise from the pin shape. In order to correctly distinguish the noise from the pin shape, a pin candidate region is extracted by binarization processing, a region between an upper limit threshold and a lower limit threshold of the height from the reference plane is extracted, and shrinkage processing is executed on the extracted region to filter out the noise (height filter processing). In a case where the area of the pin candidate region is too small, the execution unit 31d does not adopt the pin candidate region (size filter processing). In a case where the peripheral length of the pin candidate region is too long, the execution unit 31d does not adopt the pin candidate region (shape filter processing). In a case where the contour position of the pin candidate region is too far from the set shape, the pin candidate region is not adopted.

In addition, the setting unit 31c receives designation of an upper limit threshold and a lower limit threshold for the binarization processing. In a case where the upper limit threshold and the lower limit threshold for the binarization processing are obtained on the basis of each representative height of each measurement region, the setting unit 31c displays the obtained upper limit threshold and lower limit threshold as initial values on the pin height upper limit input section 254 and the pin height lower limit input section 255 of the pin tool setting window 250 illustrated in FIG. 15. The setting unit 31c individually receives designation of numerical value change with respect to the initial values of the upper limit threshold and the lower limit threshold displayed in the pin height upper limit input section 254 and the pin height lower limit input section 255, respectively.

The setting unit 31c receives designation of an extraction size for size filter processing by the extraction size input section 256 of the pin tool setting window 250 illustrated in FIG. 15. The execution unit 31d executes size filter processing of adopting a region equal to or larger than the extraction size received by the setting unit 31c as a pin candidate region and not adopting a region smaller than the extraction size as a pin candidate. As illustrated in FIG. 15, the setting unit 31c receives the designation of the position of the cursor, the designation of the numerical value, or both designations. At this time, when the setting unit 31c receives designation of a position in the measurement region on the two-dimensional display region 222, the screen generation unit 31e generates a screen displaying a symbol having a size corresponding to the extraction size at the designated position in the measurement region. The symbol is, for example, a rectangular or circular frame line. When the setting unit 31c receives the designation of the change of the extraction size by the designation of the position of the cursor or the designation of the numerical value, the screen generation unit 31e generates a screen displaying the symbol whose size has been changed according to the designation of change in the measurement region on the two-dimensional display region 222. As a result, since the size of the extraction size is intuitively grasped, it is easy to set the extraction size for the size filter processing.

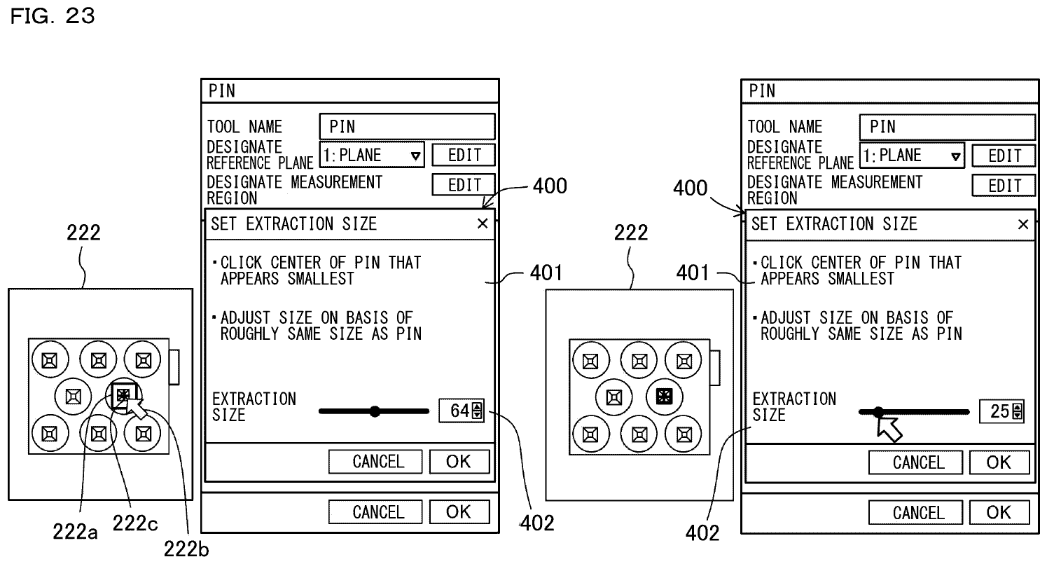

When the processing proceeds to step SA9 in FIG. 4, the designation of the initial value of the extraction size for the size filter processing may be received as illustrated in FIG. 23. An extraction size setting window 400 is displayed on the forefront to input an initial value. In the extraction size setting window 400, a guide 401 for guiding the user to what kind of adjustment should be performed, and a cursor and a numerical value box 402 for receiving the extraction size are displayed. When the designation of the position is received on the two-dimensional display region 222, a rectangular symbol 222a corresponding to a predetermined extraction size with the designated position as the center is superimposed and displayed in the two-dimensional display region 222. A mouse pointer 222b, a center 222c of the rectangular symbol 222a, and the like are also displayed in the window 400. When the initial value of the extraction size is set and the OK button is pressed, the process proceeds to step SA9 of FIG. 4. The adjustment of the extraction size is executed by receiving the designation of the position of the cursor, the designation of the numerical value, or both of them illustrated in FIG. 15 even after the process proceeds to step SA9.

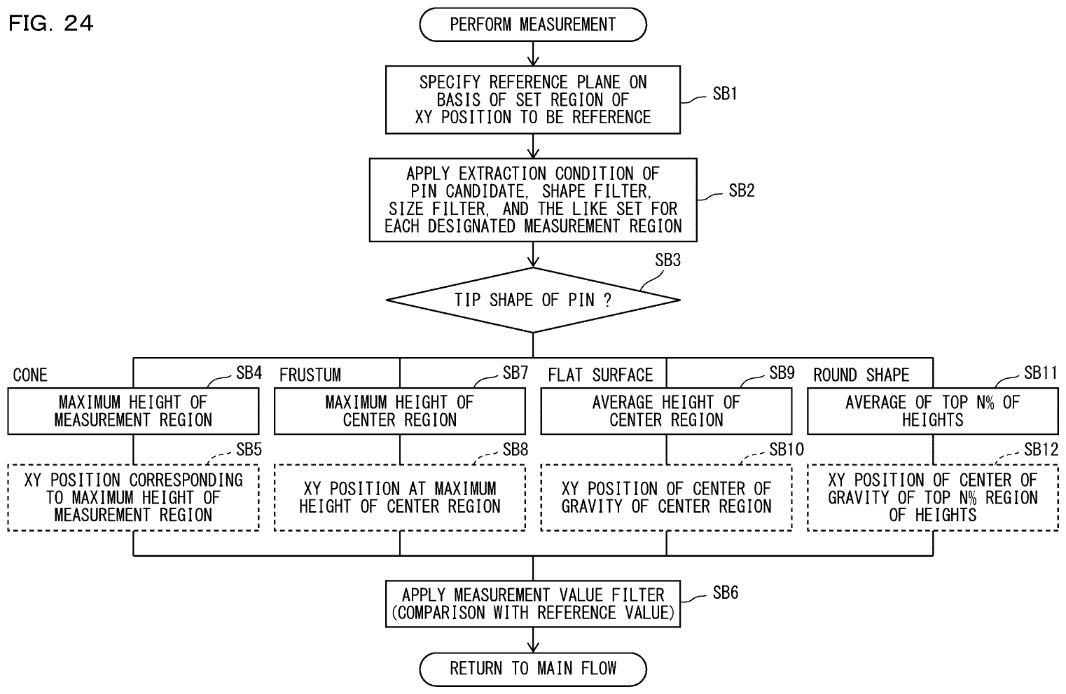

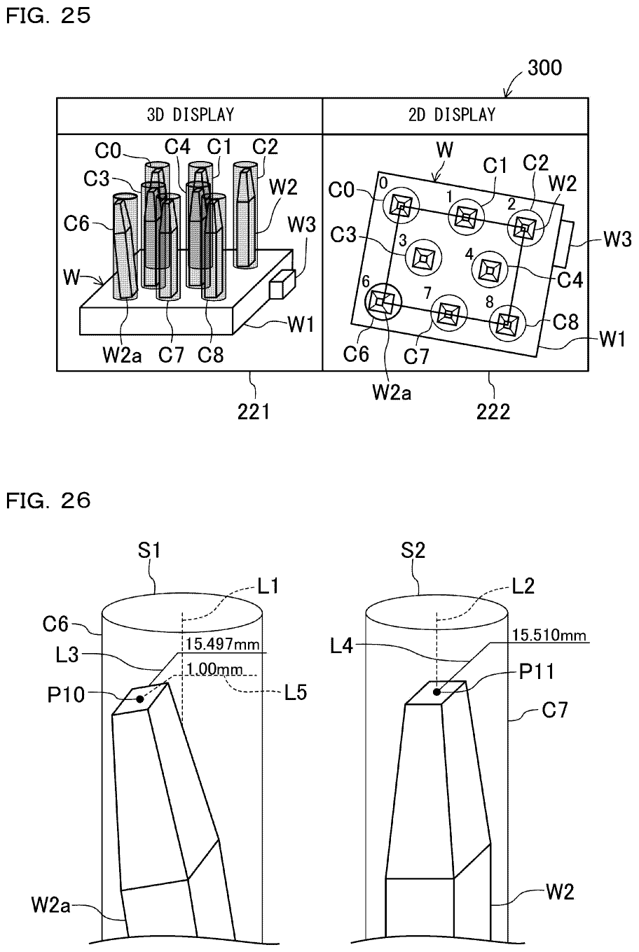

After performing step SA10 in FIG. 4, the process proceeds to step SA11. In step SA11, after the above-described setting is completed, the execution unit 31d executes measurement. FIG. 24 illustrates details of step SA11. In step SBI of the flowchart of FIG. 24, the execution unit 31d reads the X coordinate and the Y coordinate of at least three points designated at the time of setting, extracts the height of each pixel at the position specified by the X coordinate and the Y coordinate, and specifies the plane fitted to the heights of the extracted three points as the reference plane.

In step SB2, the execution unit 31d applies the set pin candidate extraction condition and shape filter, size filter, height filter, and the like to each measurement region designated at the time of setting. As a result, the execution unit 31d extracts pixels having a certain height or more from the reference plane, recognizes a block of pixels by the blob processing to obtain a pin candidate region, and obtains the shape of the blob from the area, the peripheral length, and the like of the pin candidate region. The execution unit 31d determines and filters out noise when the obtained shape of the blob is away from a circle or a rectangle which is a general pin shape. The execution unit 31d also filters out, as noise, a blob having a size equal to or smaller than a predetermined size.

In step SB3, the execution unit 31d determines the tip shape of the pin designated at the time of setting. Specifically, the execution unit 31d reads the setting contents of the pin tool, acquires information regarding the tip shape of the pin included in the read setting contents, and determines whether the tip shape of the pin designated at the time of setting is a cone, a frustum, a flat surface, or a round shape on the basis of the acquired information. In step SB3, in a case where it is determined that the tip shape of the pin designated at the time of setting is a cone, the process proceeds to step SB4. In step SB4, an algorithm in a case where the tip shape of the pin is a cone is applied, the execution unit 31d calculates the maximum height of the measurement region, and the calculated maximum height of the measurement region is set as the tip height of the pin. In step SB5, the XY position that is the maximum height of the measurement region calculated in step SB4 is specified. The specified position is the XY position of the tip of the pin. Thereafter, the process proceeds to step SB6.

In step SB3, in a case where it is determined that the tip shape of the pin designated at the time of setting is a frustum, the process proceeds to step SB7. In step SB7, an algorithm in a case where the tip shape of the pin is a frustum is applied, the execution unit 31d calculates the maximum height of the center region, and the calculated maximum height of the center region is set as the tip height of the pin. In step SB8, the XY position that is the maximum height of the center region calculated in step SB8 is specified. The specified position is the XY position of the tip of the pin. Thereafter, the process proceeds to step SB6.

In step SB3, in a case where it is determined that the tip shape of the pin designated at the time of setting is a flat surface, the process proceeds to step SB9. In step SB9, an algorithm in a case where the tip shape of the pin is a flat surface is applied, the execution unit 31d calculates the average height of the center region, and the calculated average height of the center region is set as the tip height of the pin. In step SB10, the XY position that is the average height of the center region calculated in step SB9 is specified. The specified position is the XY position of the tip of the pin. Thereafter, the process proceeds to step SB6.

In a case where it is determined in step SB3 that the tip shape of the pin designated at the time of setting is a round shape, the process proceeds to step SB11. In step SB11, an algorithm in a case where the tip shape of the pin is a round shape is applied, and the execution unit 31d calculates the average height of the top n % of the heights of the measurement region, and sets the calculated average height as the tip height of the pin. In step SB12, the XY position of the center of gravity of the region of the top n % of the heights of the measurement region is specified. The specified position is the XY position of the tip of the pin. Thereafter, the process proceeds to step SB6.

As described above, the measurement simulation can be executed by obtaining the measurement value of each pin by a different algorithm according to the tip shape of the pin. This measurement simulation may be executed by the processing device 3 illustrated in FIG. 1 or may be executed by the measurement device 100 illustrated in FIG. 2. In a case where the measurement simulation is executed by the measurement device 100 illustrated in FIG. 2, a result of the measurement simulation may be transmitted to the processing device 3 and acquired by the processing device 3. According to the result of the measurement simulation, for example, the conditions at the time of imaging, the size and position of the measurement region, and the like can be corrected.

In step SB6, the execution unit 31d applies a measurement value filter, and filters out, as noise, noise having a deviation amount in the height direction or a deviation amount in the XY position larger than a reference value. At this time, the execution unit 31d may designate a tolerance range with respect to the reference value of the height and a tolerance range with respect to the reference value of the XY position, and execute an inspection to determine whether or not the height and the XY position are within the tolerance ranges. The designation of the tolerance range is received by the setting unit 31c.

Upon completion of the flowchart illustrated in FIG. 24, the process proceeds to step SA12 of the flowchart illustrated in FIG. 4. In step SA12, a measurement result is displayed. In displaying the measurement result, the screen generation unit 31e generates a result display screen 300 (illustrated in FIG. 25) for displaying an image for the measurement result, and displays the result display screen 300 on the display unit 4. The result display screen 300 is provided with a three-dimensional display region 301 for three-dimensionally displaying the height image of the measurement object W and a two-dimensional display region 302 for two-dimensionally displaying the height image of the measurement object W. Thus, the screen generation unit 31e generates a user interface screen capable of three-dimensional display and two-dimensional display at the same time.

In the example illustrated in FIG. 25, a pin W2a provided near the left front corner is inclined beyond the tolerance range. In this case, the screen generation unit 31e displays the measurement region C6 including the pin W2a, which is the measurement element of which the measurement value is determined not to be within the tolerance range by the execution unit 31d, in the height image displayed three-dimensionally or the image displayed two-dimensionally in a form different from the case where the measurement value is determined to be within the tolerance range. Specifically, the color indicating the measurement region C6 including the pin W2a whose measurement value is not within the tolerance range is set to a color different from the color indicating the measurement regions C0 to C5, C7, and C8 including the pin W2 whose measurement value is determined to be within the tolerance range. In addition, by changing the line type surrounding the measurement region or by applying hatching or filling to the measurement region and changing the type or color of the hatching or filling, the measurement region including the measurement element determined not to be within the tolerance range and the measurement region determined to be within the tolerance range can be displayed in different forms. In addition, a display form different from the measurement region determined to be within the tolerance range can be obtained by attaching characters or symbols to the measurement region including the measurement element determined not to be within the tolerance range. The screen displaying the measurement region including the measurement element determined not to be within the tolerance range and the measurement region determined to be within the tolerance range in different forms may be displayed in only one of the three-dimensional display region 301 and the two-dimensional display region 302, or may be displayed in both of them.

In short, the result display screen 300 has a display region that two-dimensionally and three-dimensionally displays the height image on the basis of the shape data received by the main-body-side communication unit 30, and displays one or more measurement elements on the height image. Then, since the result display screen 300 includes the result display element indicating the result of the measurement performed by the execution unit 31d as a line surrounding the measurement region or hatching or filling applied to the measurement region, the user can easily grasp whether or not the height or position of the pin is within the tolerance range only by viewing the three-dimensional display region 301 or the two-dimensional display region 302.

In the present embodiment, for example, it is possible to sequentially display a plurality of three-dimensional images in the three-dimensional display region 301 by capturing the plurality of three-dimensional images in advance and switching the captured three-dimensional images by the user. By switching and displaying the captured image, it is possible to confirm whether or not the captured image can correctly follow the XYZ positional deviation, the 0 angle deviation, and the tilt deviation while viewing the three-dimensional image.

As illustrated in an enlarged manner in FIG. 26, the result display screen 300 can distinguishably display a case where the XY position of the pin tip is outside the tolerance range (left diagram) and a case where the XY position is within the tolerance range (right diagram). The pin W2a is a pin inclined beyond the tolerance range, the XY position of the tip thereof is specified as a point P10, and the point P10 is displayed on the result display screen 300. The measurement region C6 is displayed in a translucent cylindrical shape on the result display screen 300. A straight line (center line) L1 passing through the center of the measurement region C6 is also displayed on the result display screen 300. The center line L1 is a measurement reference based on the reference value. By viewing the result display screen 300, the user can easily grasp that the point P10 deviates from the straight line L1, the deviation amount, and the deviation direction. In this manner, the screen generation unit 31e generates the result display screen 300 that displays the measurement reference based on the reference value and the deviation amount of the pin W2a from the reference as result display elements.

On the other hand, in the right diagram of FIG. 26, since the measured value of the pin W2 is within the tolerance range, the point P11 indicating the XY position of the tip of the pin W2 is located on the center line L2 of the measurement region C7. On the result display screen 300 illustrated in FIG. 26, the color and line type of a circle S1 surrounding the upper end of the measurement region C6 may be different from the color and line type of the circle S2 surrounding the upper end of the measurement region C7. The color of the circle S1 can also be, for example, red so that it can be more clearly seen to be outside the tolerance range.

In FIG. 26, the height of the tip of the pin is indicated by a numerical value. That is, the screen generation unit 31e acquires the measurement value of the height of the tip of each pin obtained by the execution unit 31d, and generates the result display screen 300 that displays the acquired measurement value in association with the pin. For example, lead lines L3 and L4 starting from the tip of the pin are generated for each pin, and measurement values are displayed in association with the lead lines L3 and L4, respectively. As a result, the user can easily grasp the height of each pin.

The screen generation unit 31e can also generate a display screen that displays the separation distance between the point P10 at the tip of the pin and the center line L1. For example, a lead line L5 starting from a point P10 at the tip of the pin is generated for each pin, and the separation distance is displayed in association with the lead line L5. Both the height of the pin and the separation distance may be displayed, or only one of them may be displayed.

The measured value may be displayed, for example, in the form of a list. That is, the screen generation unit 31e enables a plurality of pins to be identified by numbers, displays the numbers in a table, and generates a list in which the measured values of the pins identified by the numbers are displayed next to the numbers, and displays the list on the display unit 4. The measurement values displayed in the list may be both the height of the pin and the XY position, or may be only one. The generated list can also be output to the outside.

Although not an essential configuration, the setting support device 1 may have a source code generation function and a function of importing the generated source code into the inspection program of the user. That is, the setting support device 1 can generate setting support information, and a text code (source code), a library, reference shape data, and the like are included as the setting support information. The setting support device 1 generates a text code including a plurality of pieces of processing program information and a measurement element and a measurement item set at the time of setting. The generated text code is associated with a library and reference shape data, respectively. The setting support device 1 outputs the text code, the library, and the reference shape data associated with each other to the inspection program of the user as setting support information. As a result, the user can execute measurement and inspection using the source code generated by the setting support device 1.

Note that, not only the source code but also communication for acquiring a three-dimensional image by communicating with the measurement head 2 and an execution library corresponding to various inspection tools can be imported. In addition, a library for easily displaying a three-dimensional image may be imported. In addition, the set registered image can also be imported.

### Various Measurement Tools

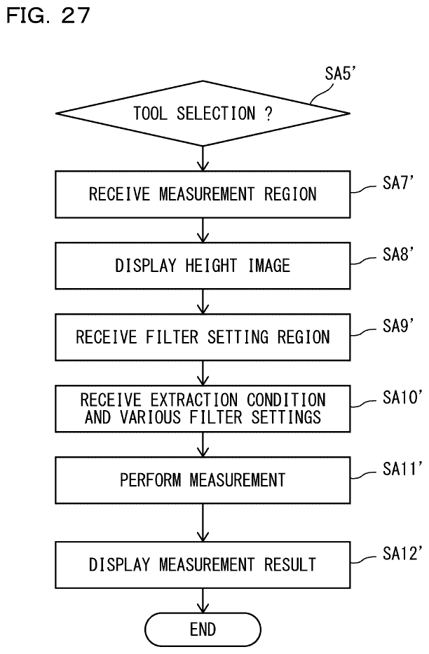

When the measurement tool is selected, the screen generation unit 31e generates a measurement tool selection user interface screen and displays the user interface screen on the display unit 4. On the measurement tool selection user interface screen, various measurement tools can be selected in addition to the pin tool, and a user can select a desired measurement tool by operating the operation unit 5 (step SA5′ in FIG. 27). The measurement object and the filter processing corresponding to the measurement tool are prepared in advance for each of various measurement tools, and even for the measurement object W that is difficult to measure except for the optimal setting, the optimal setting can be easily realized, so that the measurement is facilitated.

The measurement object of the pin tool is the representative height of the pin tip end region in each measurement region, and is the representative height of the pin tip end region from the reference plane when the reference plane is used. The measurement object of the pin tool may further include a representative position of the pin tip end region.

The measurement object of the flaw tool is a flaw with a certain depth from the reference surface in the measurement region, the presence or absence of flaws with a certain height from the reference surface, the number of flaws, the total area of all flaws, and the like. The measurement object of the flaw tool may further include a maximum depth of a concave flaw and a maximum height of a convex flaw. Further, the measurement object of the flaw tool may include each area, each maximum depth, and each maximum height of each detected individual flaw.

The measurement object of the fine flaw tool is, for each segment region in the measurement region, a flaw level indicating a flaw likelihood of the segment region, the presence or absence of flaws having a certain flaw level or more, the number of flaws, the total area of all flaws, and the like. The flaw level is obtained, for example, on the basis of a constant unevenness change between each segment region and its peripheral region. In addition, the size of the segment region corresponds to the size of the flaw to be detected. The measurement object of the fine flaw tool may further include each area of each detected individual flaw and a representative flaw level.

### Reception of Region for Filter Setting

When setting of various filters is received in various measurement tools, a height image is displayed in step SA8′, and designation of at least one filter parameter in a region or a position on the height image is received (step SA9′). Then, a symbol corresponding to the extraction size is superimposed and displayed on the height image. When the change of the extraction size is received, the symbol size on the height image is also changed according to the change of the extraction size.

In step SA10′, designation of extraction conditions and various filters is received. Thereafter, the process proceeds to steps SA11′ and SA12′. Steps SA11′ and SA12′ are the same as steps SA11 and SA12 illustrated in FIG. 4.

In step SA10′, for example, the extraction size of the pin tool corresponds to the minimum detection size adopted as the candidate region of the pin tip, and the extraction size is adjusted so that the symbol matches the tip region of the smallest pin on the height image, whereby the pin tip region and the noise can be optimally divided.

The extraction size of the flaw tool corresponds to the definition of the flaw region for obtaining the maximum depth of the concave flaw and the maximum height of the convex flaw, and by adjusting the extraction size so as to include the largest flaw region, it is possible to set the depth threshold and the height threshold for optimally dividing the flaw region and the noise. For example, when a free-form surface that fits the height image is extracted as a reference surface from the height image of the measurement object, the followability of the free-form surface changes depending on the size of the flaw by adjusting the extraction size. When the extraction size is reduced, a free-form surface fitted to follow a large flaw is extracted as a reference surface. In this case, when a difference between the height image of the measurement object and the reference surface is obtained to obtain the difference height image, a large flaw is less likely to appear. On the other hand, when the extraction size is increased, a free-form surface that does not follow a large flaw but fits a portion other than the large flaw is extracted as a reference surface. In this case, when a difference between the height image of the measurement object and the reference surface is obtained to obtain the difference height image, a large flaw appears.

The extraction size of the fine flaw tool corresponds to the size of the flaw region to be detected, and the flaw region and noise can be optimally divided by adjusting the extraction size so as to include the largest flaw region to be detected. Similarly to the flaw tool, by adjusting the extraction size, the followability to the flaw of the free-form surface extracted as the reference surface changes according to the flaw size. In addition, the size of the flaw region to be detected may correspond to the size of the segment region for obtaining the flaw level.

### Flaw Tool

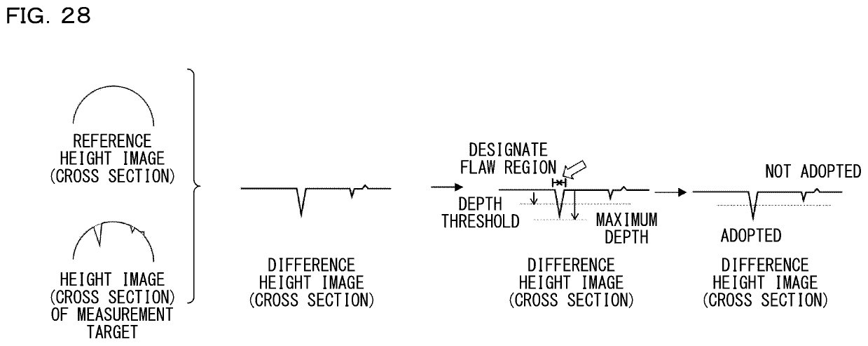

Processing content of the flaw tool will be described with reference to FIG. 28 schematically illustrating a cross section of the height image. The reference surface is acquired by executing reference surface extraction processing of extracting a free-form surface corresponding to the extraction size from the height image of the measurement object. A difference between the height image of the measurement object and the reference surface is obtained to obtain a difference height image. The designation of the position of the flaw region on the difference height image is received. If the flaw corresponding to the flaw region is a concave flaw, the maximum depth of the flaw region is obtained, and the depth threshold is obtained as a detection threshold that is a filter parameter on the basis of the maximum depth. In addition, if the flaw corresponding to the flaw region is a convex flaw, the maximum height of the flaw region is obtained, and the height threshold is obtained as a detection threshold that is a filter parameter on the basis of the maximum height. The flaw region is changed by changing the extraction size, and accordingly, the detection threshold is obtained again. When the maximum depth or the maximum height in the candidate region is equal to or more than the detection threshold value in the flaw candidate region, the candidate region is adopted as flaw, the region that does not satisfy the maximum depth or the maximum height is not adopted as the flaw.

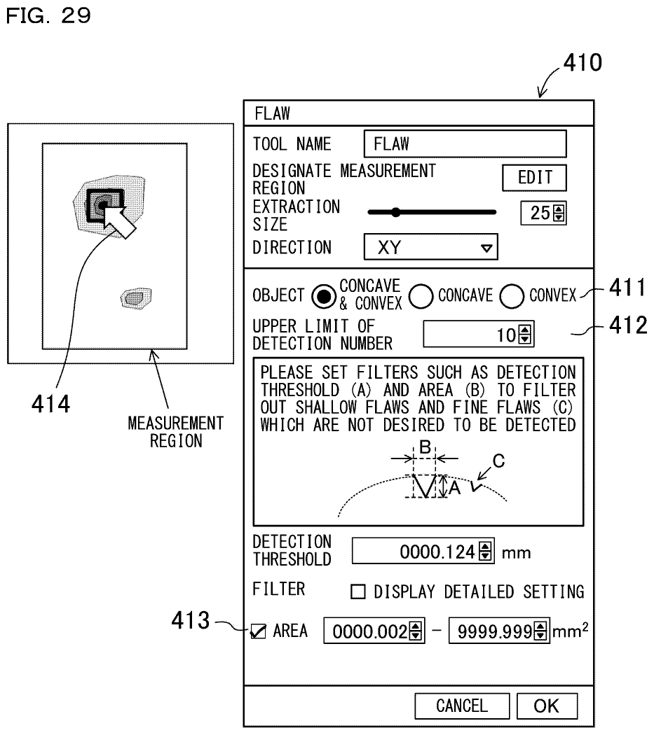

As illustrated in FIG. 29, the screen generation unit 31e may display a flaw tool window 410 on the display unit 4 so that the flaw type can be selected on the flaw tool window 410. The flaw tool window 410 is provided with a flaw type input unit 411 capable of selecting a flaw type. The flaw type includes, for example, concave and convex flows, a concave flaw, a convex flaw, and the like. When the concave and convex flows are selected by the flaw type input unit 411, both the concave flaw and the convex flaw are detected. When the concave flaw is selected by the flaw type input unit 411, the concave flaw is a detection target, but the convex flaw is not a detection target. When the convex flaw is selected by the flaw type input unit 411, the convex flaw is a detection target, but the concave flaw is not a detection target. A selection operation or the like on the flaw tool window 410 is received by the accepting unit 31b.

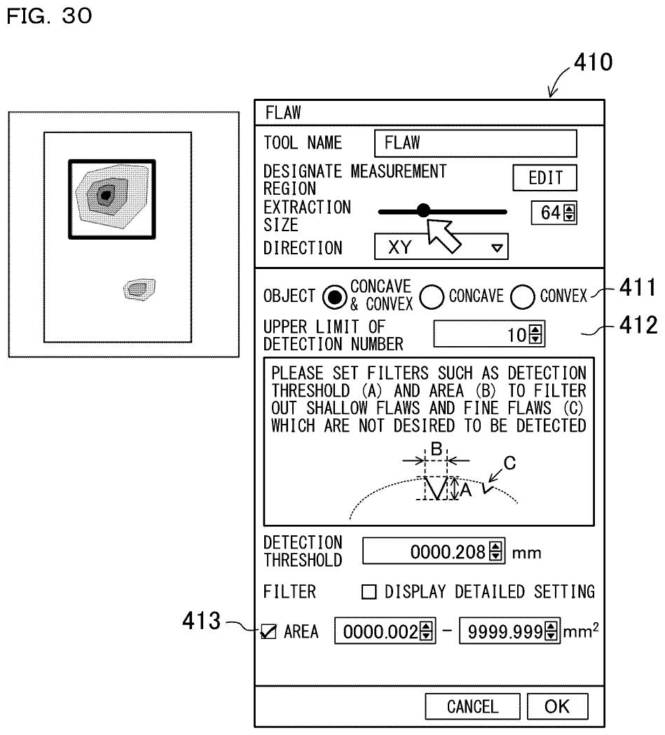

The flaw tool window 410 is provided with an upper limit number input section 412 to which an upper limit of the number of detected flaws can be input. The upper limit number input section 412 can receive and set the upper limit of the number of detected flaws. In a case where a flaw candidate region exceeding the upper limit of the number of detections is detected, a detection threshold not exceeding the upper limit of the number of detections is automatically set. The area of the flaw candidate region can be included in the filter parameter. By checking a check box 413 illustrated in FIG. 29, a candidate region between the upper limit and the lower limit of the area of the flaw candidate region is not adopted, and the other candidate regions are rejected. FIG. 29 illustrates a case where the largest flaw among the displayed flaws is designated by a mouse pointer 414. FIG. 30 illustrates a case where the detection size is adjusted to match the size of the flaw, and in the case of FIG. 30, the detection threshold is optimized.

### Fine Flaw Tool

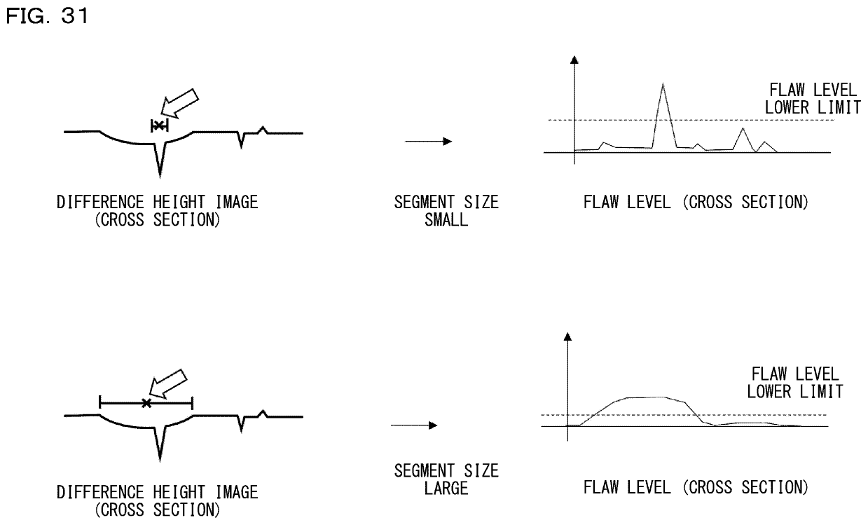

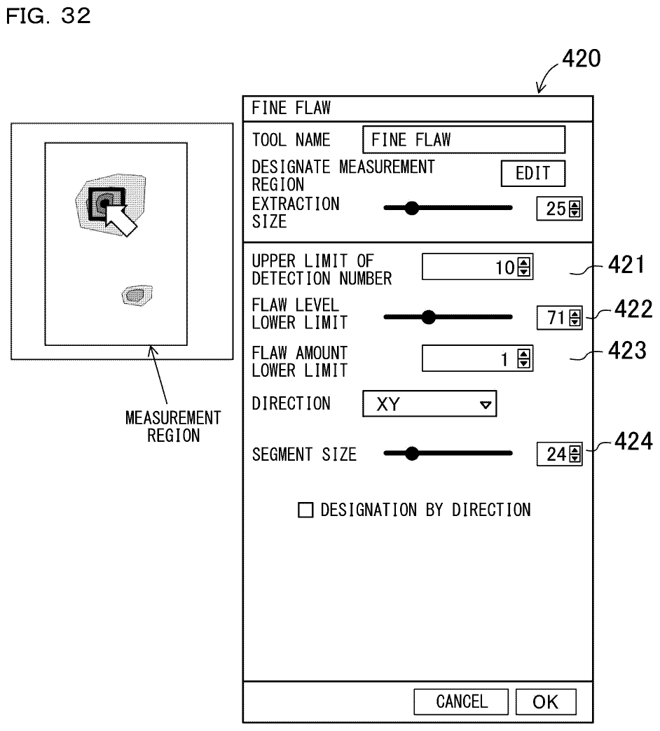

Processing contents of the fine flaw tool will be described with reference to a schematic diagram of the difference height image and FIG. 31 illustrating a difference in flaw level according to the size of the segment region. The accepting unit 31b receives designation of the position of the flaw region on the difference height image. The extraction size may correspond to the size of the segment region in addition to the followability to the flaw size when the free-form surface fitting the height image is extracted as the reference surface from the height image of the measurement object. The average height in the segment region is obtained, and the flaw level of the segment region is obtained on the basis of the difference from the peripheral segment region. FIG. 32 illustrates a fine flaw tool window 420 generated by the screen generation unit 31e and displayed on the display unit 4. The fine flaw tool window 420 is provided with an upper limit number input section 421 to which an upper limit of the number of detected flaws can be input, a flaw level lower limit input section 422 to which a lower limit of a flaw level can be input, a flaw amount lower limit input section 423 to which a lower limit of a flaw amount can be input, and a segment size input section 424 to which a segment size can be input. A selection operation or the like on the fine flaw tool window 420 is received by an accepting unit 31b.

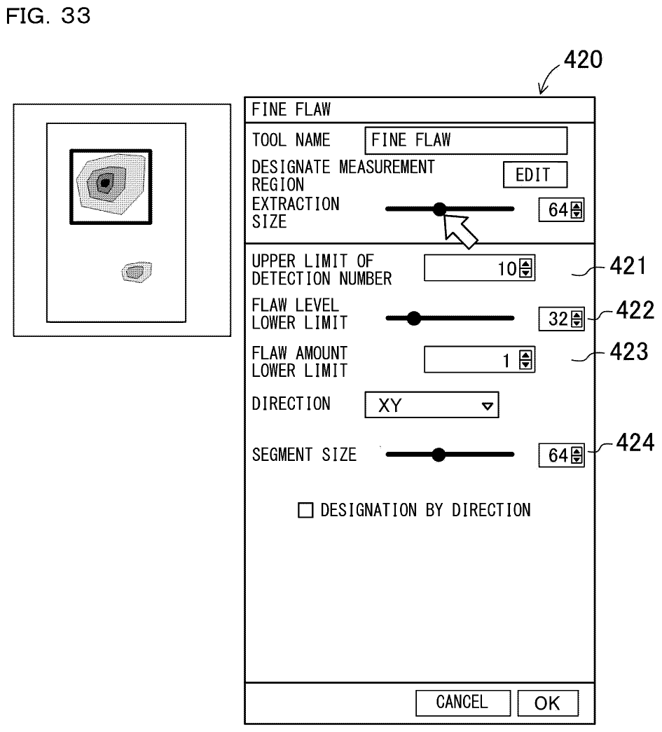

In the fine flaw tool, small flaws with respect to the segment region are averaged and are less likely to be reflected in the flaw level. In addition, a large flaw with respect to the segment size is less likely to appear as a difference from the peripheral segment region, and is less likely to be reflected in the flaw level. Therefore, a flaw corresponding to the size of the segment region is easily reflected on the flaw level. By setting the lower limit of the flaw level, a region equal to or more than the lower limit of the flaw level becomes a flaw candidate region. Furthermore, the area of the flaw candidate region can be included in the filter parameter by the flaw amount lower limit. A candidate region equal to or more than the lower limit of the flaw amount is adopted, and a candidate region less than the lower limit of the flaw amount is not adopted. FIG. 32 illustrates a case where the detection size is adjusted to match the size of the flaw, and in the case of FIG. 33, the detection threshold is optimized.

### During Operation

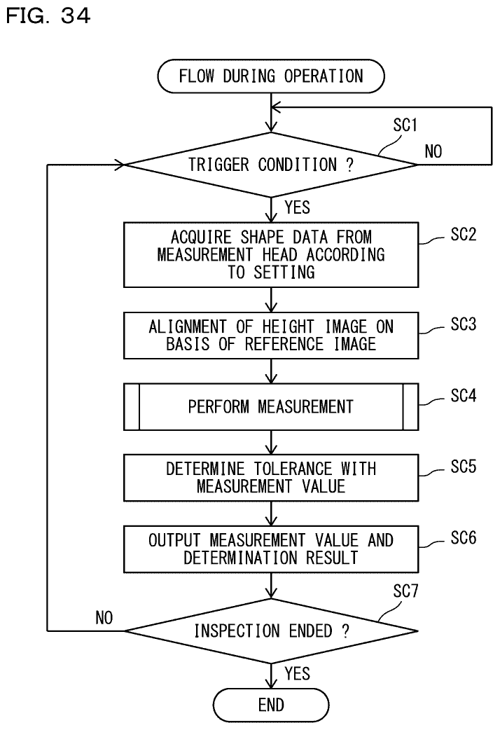

FIG. 34 is a flowchart illustrating a flow of processing at the time of operation of the measurement device 100. In step SC1, it is determined whether or not the measurement device 100 satisfies a predetermined trigger condition. In a case where the trigger condition is satisfied, the process proceeds to step SC2. In step SC2, the measurement device 100 acquires shape data from the measurement head 2 according to the setting content set at the time of setting. In step SC3, the measurement device 100 executes alignment of the height image on the basis of the reference image. In step SC4, the measurement device 100 executes measurement on each measurement region similarly to the processing illustrated in the flowchart of FIG. 34. In step SC5, it is determined whether or not the measured value is within the tolerance range. In step SC6, the measurement value obtained in step SC4 and the determination result in step SC5 are output to an external device such as a programmable logic controller (PLC). Here, in a case where the tolerance determination in step SC5 is not executed, in step SC6, the measurement value obtained in step SC4 is output to an external device. In step SC7, it is determined whether or not the inspection has ended.

The above-described embodiments are merely examples in all respects, and should not be construed in a limiting manner. Further, all modifications and changes falling within the equivalent scope of the claims are within the scope of the present invention.

As described above, the setting support device and the setting support program for the measurement device according to the present disclosure can be used, for example, in a case of measuring a pin or the like of a measurement object.

What is claimed is:

1. A setting support device for a measurement device comprising:
a receiving unit that receives shape data;
a setting unit that sets one or more measurement elements and a measurement item using the one or more measurement elements;
an execution unit that executes measurement of the measurement item set by the setting unit, on the shape data received by the receiving unit;
and a screen generation unit that generates a display screen, the display screen including a display region for two-dimensionally and/or three-dimensionally displaying a height image, based on the shape data received by the receiving unit, and the one or more measurement elements on the height image, the display screen including a result display element indicating a result of the measurement executed by the execution unit,
wherein the setting unit includes a tool for measuring a predetermined measurement object as the measurement item, the setting unit receives, in response to selection of the tool, designation of a measurement region on the height image and designation of a target region for specifying a measurement object in the measurement region, and sets a tool including a measurement region for measuring the measurement object and a filter parameter according to the designation of the measurement region, a size of the target region, and/or a representative height in the target region,
the screen generation unit displays a symbol according to the target region on the height image; and
the execution unit specifies the measurement object according to the filter parameter in the measurement region on a basis of setting of the tool, and executes measurement of the tool on a basis of a measurement value of the specified measurement object.

2. The setting support device for a measurement device according to claim 1, wherein
the setting unit receives designation of a reference plane and sets a tool for measuring a pin in response to reception of the designation of the reference plane, and
the execution unit obtains a measurement value from the reference plane in the measurement region.

3. The setting support device for a measurement device according to claim 1, wherein
the setting unit receives designation of change in size of the target region and sets a tool including a filter parameter according to the size of the target region, and
the screen generation unit displays a symbol according to the change in size of the target region on the height image.

4. The setting support device for a measurement device according to claim 1, wherein
the setting unit includes a tool for measuring a pin as the measurement item, and sets a tool including a filter parameter corresponding to a size of the target region, and
the execution unit specifies a region larger than the filter parameter in the measurement region as the measurement object based on the setting of the tool.

5. The setting support device for a measurement device according to claim 1, wherein
the setting unit sets a plurality of measurement regions corresponding to pins, and
the execution unit obtains a representative height of a pin tip and a representative position of the pin tip in each of the plurality of measurement regions as measurement of the tool.

6. The setting support device for a measurement device according to claim 1, wherein
the setting unit includes a tool for measuring a flaw as the measurement item, and sets a tool including a filter parameter corresponding to at least one of a representative depth or a representative height from a reference surface in the target region, and
the execution unit specifies a region deeper than the filter parameter in the measurement region as the measurement object on a basis of the setting of the tool.

7. The setting support device for a measurement device according to claim 6, wherein the execution unit obtains a number of flaws and a size of the flaws in the measurement region as measurement of the tool.

8. The setting support device for a measurement device according to claim 7, wherein the execution unit further obtains a representative depth of a flaw or a representative height of a flaw in the measurement region as measurement of the tool.

9. The setting support device for a measurement device according to claim 1, wherein
the setting unit includes a tool for measuring a fine flaw as the measurement item, and sets a tool including a filter parameter corresponding to a size of the target region, and
the execution unit specifies a region having a size close to the filter parameter in the measurement region as the measurement object on a basis of the setting of the tool.

10. The setting support device for a measurement device according to claim 9, wherein the execution unit obtains a number of flaws and a size of the flaws in the measurement region as measurement of the tool.

11. The setting support device for a measurement device according to claim 1, wherein the execution unit executes binarization processing using a threshold set in advance on the shape data, then sets a region extracted by executing blob processing as a pin candidate region, and executes filter processing on the pin candidate region.

12. The setting support device for a measurement device according to claim 11, wherein the execution unit executes, as the filter processing, shape filter processing in which a shape of the pin candidate region is a target of filtering.

13. The setting support device for a measurement device according to claim 11, wherein the execution unit executes, as the filter processing, height filter processing in which a height of the pin candidate region is a target of filtering.

14. The setting support device for a measurement device according to claim 11, wherein the execution unit executes, as the filter processing, size filter processing in which a size of the pin candidate region is a target of filtering.

15. The setting support device for a measurement device according to claim 1, wherein the setting unit specifies existence ranges of the plurality of measurement regions on a basis of designation of three points on a height image by a user.

16. The setting support device for a measurement device according to claim 15, wherein the setting unit receives designation of a number of the measurement regions arranged in the existence range in a row direction, a number of the measurement regions in a column direction, and a shape of the measurement region.

17. The setting support device for a measurement device according to claim 15, wherein the setting unit receives a change in size of a first measurement region that is an arbitrary one of a plurality of the measurement regions arranged in the existence range, and when receiving a change in size of the first measurement region, the setting unit sets a size of another measurement region to a size after the change of the first measurement region.

18. The setting support device for a measurement device according to claim 2, wherein the screen generation unit generates a display screen that displays a measurement reference based on a reference value and a deviation amount of the pin with respect to the reference as the result display element.

19. The setting support device for a measurement device according to claim 18, wherein
the setting unit receives designation of a tolerance range with respect to the reference value,
the execution unit determines whether or not the measurement value is within the tolerance range, and
the screen generation unit displays the measurement region including the measurement element of which the measurement value is determined not to be within the tolerance range by the execution unit in a form different from a case where it is determined to be within the tolerance range in the height image displayed three-dimensionally.

20. A storage medium storing a setting support program for a measurement device executable by a processing device, the setting support program causing the processing device to execute:
processing of receiving shape data;
processing of setting one or more measurement elements and a measurement item using the one or more measurement elements;
processing of measuring the measurement item, on the shape data; and
processing of generating a display screen, the display screen including a display region for two-dimensionally and/or three-dimensionally displaying a height image based on the shape data and the one or more measurement elements on the height image, the display screen including a result display element indicating a result of the measurement,
the setting support program further causing the processing device to execute:
processing of receiving, in response to selection of a tool for measuring a predetermined measurement object, designation of a measurement region on the height image and designation of a target region for specifying a measurement object in the measurement region, and setting a tool including a measurement region for measuring the measurement object and a filter parameter according to the designation of the measurement region, a size of the target region, and/or a representative height in the target region; and
processing of displaying a symbol according to the target region on the height image, specifying the measurement object according to the filter parameter in the measurement region on a basis of setting of the tool, and executing measurement of the tool on a basis of a measurement value of the specified measurement object.
